(19) United States
(12) Patent Application Publication
(10) Pub. No.: US 2007/0073999 A1
(43) Pub. Date: Mar. 29, 2007

(54) Hardware acceleration system for logic simulation using shift register as local cache with path for bypassing shift register

(76) Inventors: Henry T. Verheyen, San Jose, CA (US); William Watt, San Jose, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/291,164

(22) Filed: Nov. 30, 2005

Related U.S. Application Data
(63) Continuation-in-part of application No. 11/238,505, filed on Sep. 28, 2005.

(51) Int. Cl. G06F 15/00

(52) U.S. Cl. 712/11

(57) ABSTRACT

A simulation processor includes multiple processor units and an interconnect system that communicatively couples the processor units to each other. Each of the processor units includes a processor element configurable to simulate at least a logic operation, and a shift register for storing intermediate values generating during the logic simulation. Each of the processor units further includes one or more multiplexers for selecting one of the entries of the shift register as outputs to be coupled to the interconnect system. Each of the processor units can also include one or more bypass multiplexers coupled between the output of the processor element and the interconnect system, for providing a path for bypassing the shift register to provide the output of the processor element directly to the interconnect system.

### CROSS-REFERENCE TO RELATED APPLICATION

This application is a continuation-in-part application of, and claims priority under 35 U.S.C. §120 from, co-pending U.S. patent application Ser. No. 11/238,505, entitled “Hardware Acceleration System for Logic Simulation Using Shift Register as Local Cache,” filed on Sep. 28, 2005.

### BACKGROUND OF THE INVENTION

1. Field of the Invention

The present invention relates generally to VLIW (Very Long Instruction Word) processors, including for example simulation processors that may be used in hardware acceleration systems for logic simulation. More specifically, the present invention relates to the use of shift registers as the local cache in such processors.

2. Description of the Related Art

Simulation of a logic design typically requires high processing speed and a large number of operations due to the large number of gates and operations and the high speed of operation typically present in the logic design for modern semiconductor chips. One approach for logic simulation is software-based logic simulation (i.e., software simulators) where the logic is simulated by computer software executing on general purpose hardware. Unfortunately, software simulators typically are very slow. Another approach for logic simulation is hardware-based logic simulation (i.e., hardware emulators) where the logic of the semiconductor chip is mapped on a dedicated basis to hardware circuits in the emulator, and the hardware circuits then perform the simulation. Unfortunately, hardware emulators typically require high cost because the number of hardware circuits in the emulator increases according to the size of the simulated logic design.

Still another approach for logic simulation is hardware-accelerated simulation. Hardware-accelerated simulation typically utilizes a specialized hardware simulation system that includes processor elements configurable to emulate or simulate the logic designs. A compiler is typically provided to convert the logic design (e.g., in the form of a netlist or RTL (Register Transfer Language) to a program containing instructions which are loaded to the processor elements to simulate the logic design.

Hardware-accelerated simulation does not have to scale proportionally to the size of the logic design, because various techniques may be utilized to break up the logic design into smaller portions and then load these portions of the logic design to the simulation processor. As a result, hardware-accelerated simulators typically are significantly less expensive than hardware emulators. In addition, hardware-accelerated simulators typically are faster than software simulators due to the hardware acceleration produced by the simulation processor.

However, hardware-accelerated simulators generally require that instructions be loaded onto the simulation processor for execution and the data path for loading these instructions can be a performance bottleneck. For example, a simulation processor might include a large number of processor elements, each of which includes an addressable register as a local cache to store intermediate values generated during the logic simulation. The register requires an input address signal to determine the location of the particular memory cell at which the intermediate value is to be stored. This input address signal typically is included as part of the instruction sent to the processor element, which can significantly increase the instruction length and exacerbate the instruction bandwidth bottleneck.

For example, in order to select one memory cell out of a local cache register that has 2^{N} memory cells (i.e., the “depth” of the register is 2^{N}, e.g., the “depth” is 256 for N=8), an input address signal of at least N bits is required. If these bits are included as part of the instruction, then the instruction length will be increased by at least N bits for each processor unit. Assuming that this architecture is available on a per-processor unit basis (non-shared local cache), if the simulation processor contains n processor elements, then a total n×N bits is added to the overall size of the instruction word (e.g., for n=128 and N=8, this amounts to an additional 1024 bits). On the hardware side, additional circuitry will be needed to allow the register to be addressable. This adds to the cost, size and complexity of the simulation processor.

Therefore, there is a need for a simulation processor using a different type of local cache memory requiring fewer bits in the instructions that are used by the simulation processor. There is also a need for a simulation processor obviating or at least reducing the need for additional circuitry, such as input multiplexers to support the addressability of registers of the simulation processor.

### SUMMARY OF THE INVENTION

The present invention provides a simulation processor for performing logic simulation of logic operations, where intermediate values generated by the simulation processor during the logic simulation are stored in shift registers. The simulation processor includes a plurality of processor units and an interconnect system (e.g., a crossbar) that communicatively couples the processor units to each other. As compared to an addressable register, the use of a shift register as local cache reduces the instruction length and also simplifies the hardware design of the simulation processor.

Each of the processor units includes a processor element configurable to simulate at least one of the logic operations, and a shift register associated with the processor element and including a plurality of entries to store intermediate values during operation of the processor element. The shift register is coupled to receive an output of the processor element.

Each of the processor units may optionally include any number of multiplexers selecting entries of the shift register in response to selection signals. The selected entries may then be routed to various locations, for example to the inputs of other processor units via the interconnect system. Each of the processor units may optionally include a local memory associated with the shift register for storing data from the shift register and loading the data to the shift register, in some sense acting as overflow memory for the shift register.

In various embodiments of the present invention, each of the processor units further comprises one or more of the following: a first multiplexer selecting either the output of the processor element or a last entry of the shift register in response to a first selection signal as input to the shift register, a second multiplexer selecting one of the entries of the shift register in response to a second selection signal, a third multiplexer selecting another one of the entries of the shift register in response to a third selection signal, a fourth multiplexer selecting either the output of the processor element or an output of the local memory in response to a fourth selection signal, a fifth multiplexer selecting either an output of the second multiplexer or the last entry of the shift register in response to a fifth selection signal, and a sixth multiplexer selecting either an output of the third multiplexer or an output of the fourth multiplexer in response to the fifth selection signal.

In a second embodiment of the present invention, each of the processor units further comprises a first multiplexer selecting either a mid-entry of the shift register or a last entry of the shift register in response to a first selection signal, and a second multiplexer selecting either an output of the processor element or an output of the first multiplexer, in response to a second selection signal, as an input to the shift register. The processor unit can further include a local memory associated with the shift register for storing data from the processor element and loading the data to the processor element, a third multiplexer selecting one of the entries of the shift register in response to a third selection signal, a fourth multiplexer selecting another one of the entries of the shift register in response to a fourth selection signal having one more bit than the third selection signal, a fifth multiplexer selecting either the output of the processor element or an output of the local memory in response to a fifth selection signal, a sixth multiplexer selecting either an output of the third multiplexer or the output of the first multiplexer in response to the first selection signal, and a seventh multiplexer selecting either an output of the fourth multiplexer or an output of the fifth multiplexer in response to the first selection signal.

The simulation processor of the present invention has the advantage that it may reduce the instruction length, because the shift register does not require any input address signals. Also, input multiplexers are not necessarily required to select cells of the shift register. The simulation process of the present invention has the additional advantage that the shift register is interconnected with the local memory in such a way that a store mode and a load mode for the processor element are non-blocking with respect to an evaluation mode. That is, the store mode and the load mode may be performed simultaneously with the evaluation mode.

In a third embodiment of the present invention, each of the processor units further comprises one or more first-path multiplexers coupled between the output of the processor element and the interconnect system, where the first-path multiplexers provide a path for bypassing the shift register to provide the output of the processor element directly to the interconnect system, and one or more second-path multiplexers coupled between the shift register and the interconnect system, where each of the second-path multiplexers selects one of the entries of the shift register and further transfers the selected entry to the interconnect system. The first-path multiplexers provide a path for the output of the processor element to bypass the shift register and be fed directly to the interconnect system. This enables the simulation processor to perform the simulation in one less cycle, because one cycle for accessing the shift register can be eliminated when the shift register is bypassed.

Other aspects of the invention include systems corresponding to the devices described above, applications for these devices and systems, and methods corresponding to all of the foregoing. Another aspect of the invention includes VLIW processors that use shift registers as local cache but for purposes other than logic simulation.

### BRIEF DESCRIPTION OF THE DRAWINGS

The teachings of the present invention can be readily understood by considering the following detailed description in conjunction with the accompanying drawings. Like reference numerals are used for like elements in the accompanying drawings.

FIG. 1 is a block diagram illustrating a hardware-accelerated logic simulation system according to one embodiment of the present invention.

FIG. 2 is a block diagram illustrating a simulation processor in the hardware-accelerated logic simulation system according to one embodiment of the present invention.

FIG. 3 is a circuit diagram illustrating a single processor unit of the simulation processor according to a first embodiment of the present invention.

FIG. 3A is a modified circuit diagram of the processor unit of FIG. 3, illustrating an evaluation mode for the processor unit.

FIG. 3B is a modified circuit diagram of the processor unit of FIG. 3, illustrating a no-operation mode for the processor unit.

FIG. 3C is a modified circuit diagram of the processor unit of FIG. 3, illustrating a load mode for the processor unit.

FIG. 3D is a modified circuit diagram of the processor unit of FIG. 3, illustrating a store mode for the processor unit.

FIG. 4 is a circuit diagram illustrating a single processor unit of the simulation processor in the hardware accelerated logic simulation system according to a second embodiment of the present invention.

FIG. 5 is a circuit diagram illustrating a single processor unit of the simulation processor according to a third embodiment of the present invention.

FIG. 5A is a modified circuit diagram of the processor unit of FIG. 5, illustrating a first type of evaluation mode for the processor unit.

FIG. 5B is a modified circuit diagram of the processor unit of FIG. 5, illustrating a second type of evaluation mode for the processor unit.

FIG. 5C is a modified circuit diagram of the processor unit of FIG. 5, illustrating a first type of store mode for the processor unit.

FIG. 5D is a modified circuit diagram of the processor unit of FIG. 5, illustrating a second type of store mode for the processor unit.

FIG. 5E is a modified circuit diagram of the processor unit of FIG. 5, illustrating a first type of load mode for the processor unit.

FIG. 5F is a modified circuit diagram of the processor unit of FIG. 5, illustrating a second type of load mode for the processor unit.

FIG. 5G is a modified circuit diagram of the processor unit of FIG. 5, illustrating a first type of no-operation mode for the processor unit.

FIG. 6A is a circuit diagram illustrating a single processor unit of the simulation processor according to a fourth embodiment of the present invention, where the processor element performs an AOI3 function in a first type of no-operation mode.

FIG. 6B is a circuit diagram illustrating the AOI3 function of the processor element in detail.

FIG. 6C is a circuit diagram illustrating a single processor unit of the simulation processor according to the fourth embodiment of the present invention, where the processor element performs the AOI3 function in a second type of no-operation mode.

FIG. 7A is a circuit diagram illustrating a single processor unit of the simulation processor according to the fifth embodiment of the present invention, where the processor element performs a multiplexer (MUX) function in a first type of no-operation mode.

FIG. 7B is a circuit diagram illustrating the MUX function of the process element in detail.

FIG. 7C is a circuit diagram illustrating a single processor unit of the simulation processor according to the fifth embodiment of the present invention, where the processor element performs the MUX function in a second type of no-operation mode.

FIG. 8 is a circuit diagram illustrating a single processor unit of the simulation processor according to a sixth embodiment of the present invention.

FIG. 9A is a symbolic diagram, generalizing the embodiment of FIG. 3.

FIG. 9B is a symbolic diagram, generalizing the embodiment of FIG. 8.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF EMBODIMENTS

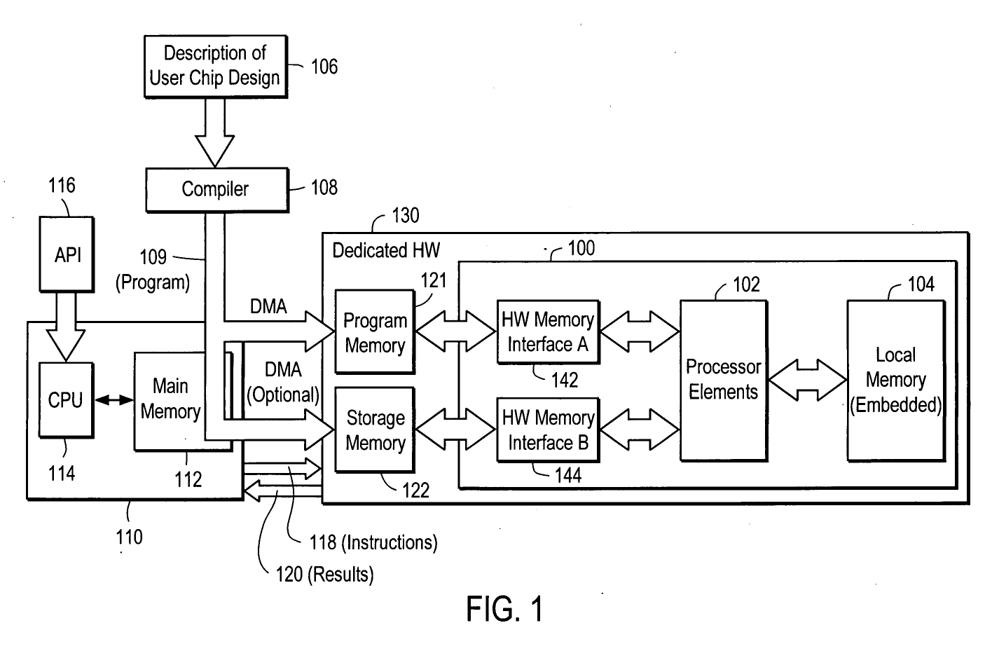

FIG. 1 is a block diagram illustrating a hardware accelerated logic simulation system according to one embodiment of the present invention. The logic simulation system includes a dedicated hardware (HW) simulator 130, a compiler 108, and an API (Application Programming Interface) 116. The computer 110 includes a CPU 114 and a main memory 112. The API 116 is a software interface by which the host computer 110 controls the simulation processor 100. The dedicated HW simulator 130 includes a program memory 121, a storage memory 122, and a simulation processor 100 that includes processor elements 102, an embedded local memory 104, a hardware (HW) memory interface A 142, and a hardware (HW) memory interface B 144.

The system shown in FIG. 1 operates as follows. The compiler 108 receives a description 106 of a user chip or logic design, for example, an RTL (Register Transfer Language) description or a netlist description of the logic design. The description 106 typically represents the logic design as a directed graph, where nodes of the graph correspond to hardware blocks in the design. The compiler 108 compiles the description 106 of the logic design into a program 109, which maps the logic design 106 against the processor elements 102 to simulate the logic design 106. The program 109 may also include the test environment (testbench) to simulate the logic design 106 in addition to representing the chip design 106 itself. For further descriptions of example compilers 108, see United States Patent Application Publication No. US 2003/0105617 A1, “Hardware acceleration system for logic simulation,” published on Jun. 5, 2003, which is incorporated herein by reference. See especially paragraphs 191-252 and the corresponding figures. The instructions in program 109 are stored in main memory 112.

The simulation processor 100 includes a plurality of processor elements 102 for simulating the logic gates of the logic design 106 and a local memory 104 for storing instructions and data for the processor elements 102. In one embodiment, the HW simulator 130 is implemented on a generic PCI-board using an FPGA (Field-Programmable Gate Array) with PCI (Peripheral Component Interconnect) and DMA (Direct Memory Access) controllers, so that the HW simulator 130 naturally plugs into any general computing system 110. The simulation processor 100 forms a portion of the HW simulator 130. Thus, the simulation processor 100 has direct access to the main memory 112 of the host computer 110, with its operation being controlled by the host computer 110 via the API 116. The host computer 110 can direct DMA transfers between the main memory 112 and the memories 121, 122 on the HW simulator 130, although the DMA between the main memory 112 and the memory 122 may be optional.

The host computer 110 takes simulation vectors (not shown) specified by the user and the program 109 generated by the compiler 108 as inputs, and generates board-level instructions 118 for the simulation processor 100. The simulation vector (not shown) includes values of the inputs to the netlist 106 that is simulated. The board-level instructions 118 are transferred by DMA from the main memory 112 to the memory 121 of the HW simulator 130. The memory 121 also stores results 120 of the simulation for transfer to the main memory 112. The memory 122 stores user memory data, and can alternatively (optionally) store the simulation vectors (not shown) or the results 120. The memory interfaces 142, 144 provide interfaces for the processor elements 102 to access the memories 121, 122, respectively.

The processor elements 102 execute the instructions 118 and, at some point, return simulation results 120 to the computer 110 also by DMA. Intermediate results may remain on-board for use by subsequent instructions. Executing all instructions 118 simulates the entire netlist 106 for one simulation vector. A more detailed discussion of the operation of a hardware-accelerated simulation system such as that shown in FIG. 1 can be found in United States Patent Application Publication No. US 2003/0105617 A1 published on Jun. 5, 2003, which is incorporated herein by reference in its entirety.

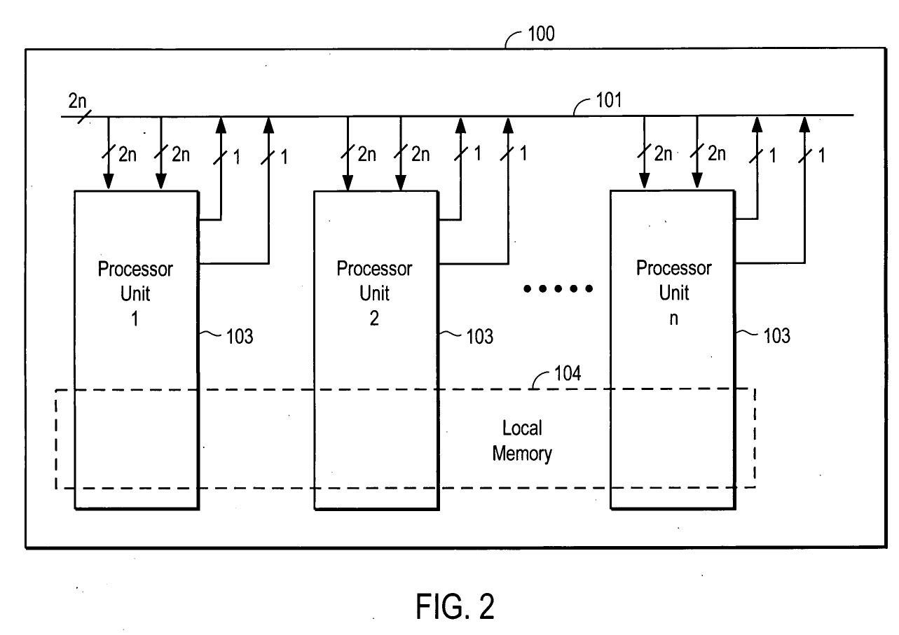

FIG. 2 is a block diagram illustrating the simulation processor 100 in the hardware-accelerated logic simulation system according to one embodiment of the present invention. The simulation processor 100 includes n processor units 103 (Processor Unit 1, Processor Unit 2, . . . . Processor Unit n) that communicate with each other through an interconnect system 101.

In this example, the interconnect system is a non-blocking crossbar. For example, each processor unit can take up to two inputs from the crossbar, so for n processor units, 2n input signals must be available allowing the input signals to select from 2n signals (denoted by the inbound arrows with slash and notation “2n”). Each processor unit has to also generate up to two outputs for the crossbar (denoted by the outbound arrows with slash and notation “1”). For n processor units, this produces the 2n output signals. Thus, the crossbar is a 2n (output from the processor units)×2n (inputs to the processor units) crossbar that allows each input of each processor unit 103 to be coupled to any output of any processor unit 103. In this way, an intermediate value calculated by one processor unit can be made available for use as an input for calculation by any other processor unit. For a simulation processor comprised of n processor units, each having 2 inputs, 2n signals must be selectable in the crossbar for a non-blocking architecture. If each processing unit is identical, they must each supply 2 variables into the crossbar. This yields a 2n×2n crossbar. Blocking architectures, non-homogeneous architectures, optimized architectures (for specific design styles), or shared architectures (in which processor units either share the address bits, or share either the input or the output lines into the crossbar), etc. would not have to follow a 2n×2n crossbar. Many other combinations of the crossbar are therefore also possible. This describes a 2n×2n crossbar, but the processor elements (PEs) in the process units may be extended to 3 or more inputs (and outputs), in which case a Mn×Mn crossbar would be used, where M is the number of inputs (and outputs) on each PE, and n is the number of PEs.

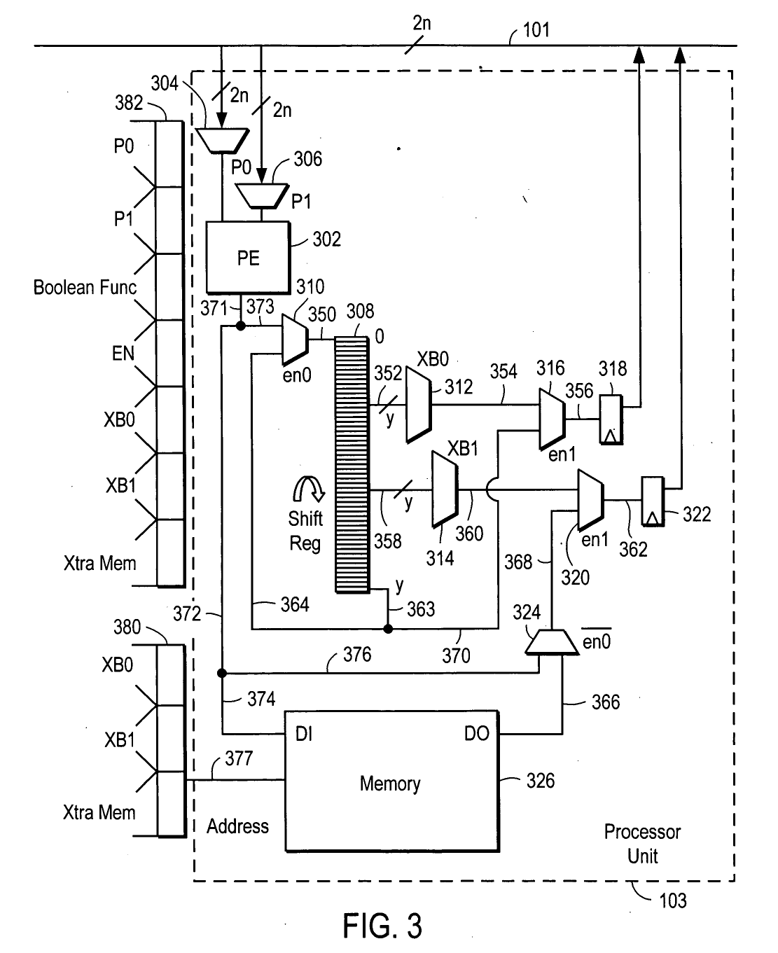

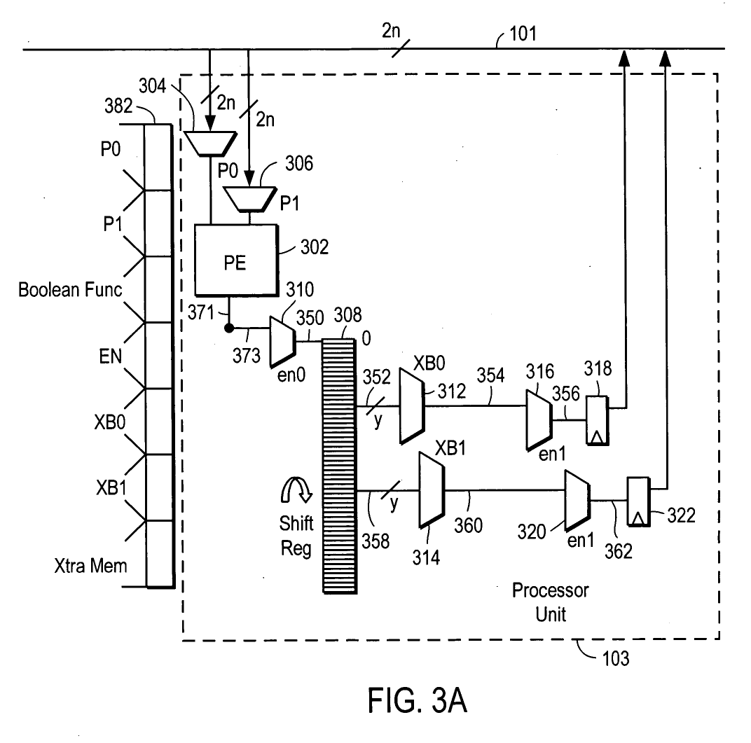

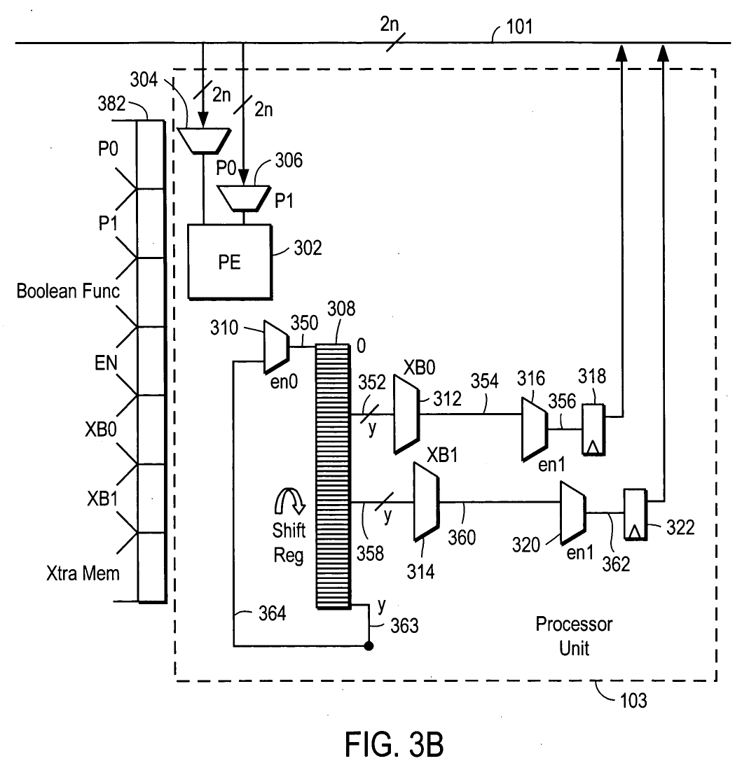

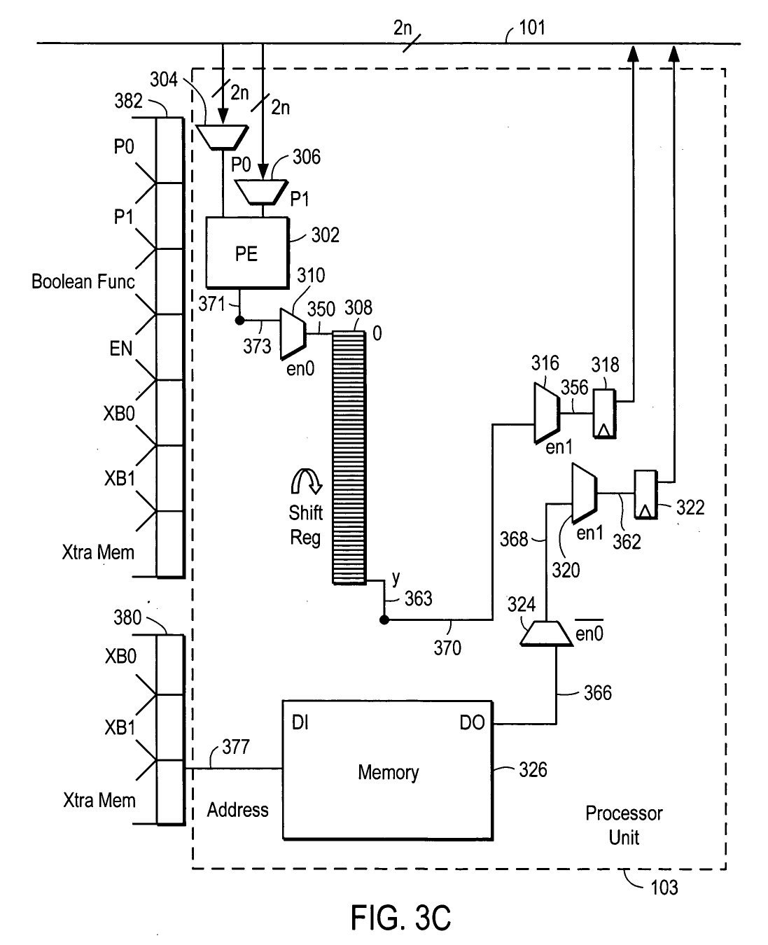

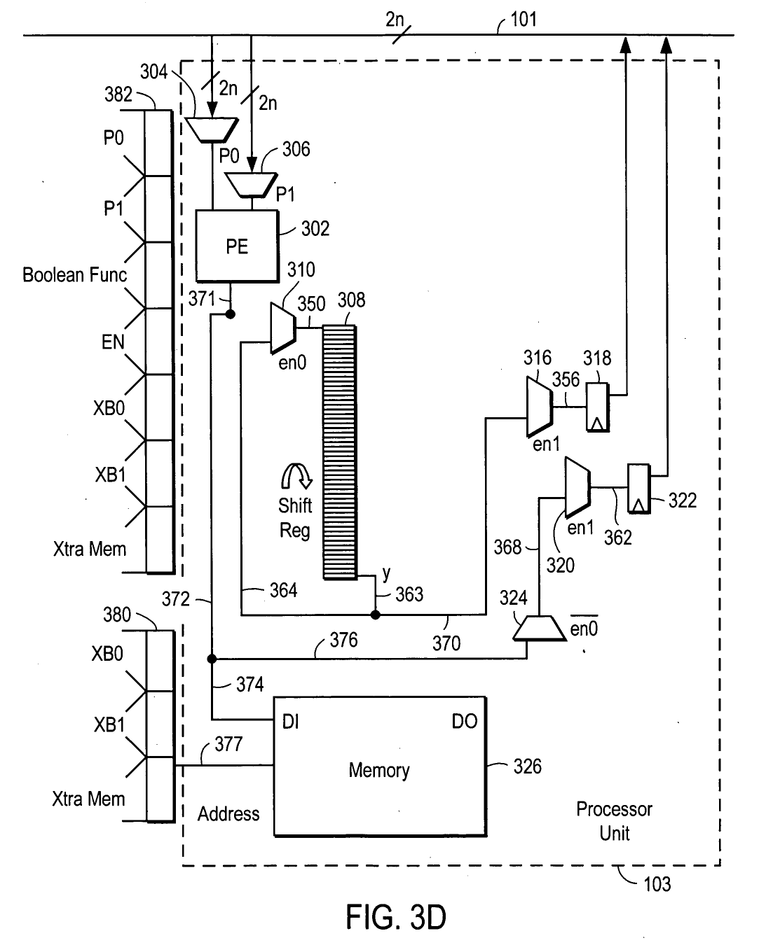

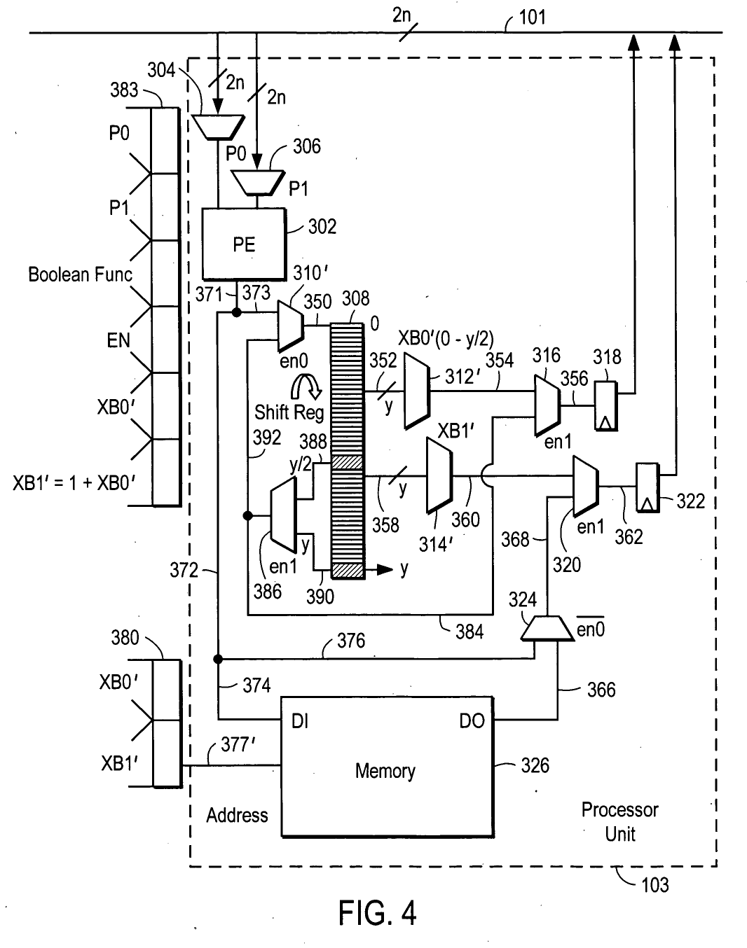

As will be shown in more detail with reference to FIGS. 3 and 4, each of the processor units 103 includes a processor element (PE), a shift register, and a corresponding part of the local memory 104 as its memory. Therefore, each processor unit 103 can be configured to simulate at least one logic gate of the logic design 106 and store intermediate or final simulation values during the simulation.

FIG. 3 is a circuit diagram illustrating a single processor unit 103 of the simulation processor 100 in the hardware accelerated logic simulation system according to a first embodiment of the present invention. Each processor unit 103 includes a processor element (PE) 302, a shift register 308, an optional memory 326, multiplexers 304, 306, 310, 312, 314, 316, 320, 324, and flip flops 318, 322. The processor unit 103 is controlled by instructions 118 (shown as 382 in FIG. 3). The instruction 382 has fields P0, P1, Boolean Func, EN, XB0, XB1, and Xtra Mem in this example. Let each field X have a length of X bits. The instruction length is then the sum of P0, P1, Boolean Func, EN, XB0, XB1, and Xtra Mem in this example.

A crossbar 101 interconnects the processor units 103. The crossbar 101 has 2n bus lines, if the number of PEs 302 or processor units 103 in the simulation processor 100 is n and each processor unit has two inputs and two outputs to the crossbar. In a 2-state implementation, n represents n signals that are binary (either 0 or 1). In a 4-state implementation, n represents n signals that are 4-state coded (0, 1, X or Z) or dual-bit coded (e.g., 00, 01, 10, 11). In this case, we also refer to the n as n signals, even though there are actually 2n electrical (binary) signals that are being connected. Similarly, in a three-bit encoding (8-state), there would be 3n electrical signals, and so forth.

The PE 302 is a configurable ALU (Arithmetic Logic Unit) that can be configured to simulate any logic gate with two or fewer inputs (e.g., NOT, AND, NAND, OR, NOR, XOR, constant 1, constant 0, etc.). The type of logic gate that the PE 302 simulates depends upon Boolean Func, which programs the PE 302 to simulate a particular type of logic gate. The number of bits in Boolean Func is determined in part by the number of different types of unique logic gates that the PE 302 is to simulate. For example, if each of the inputs is 2-state logic (i.e., a single bit, either 0 or 1) and the output is also 2-state, then the corresponding truth table is a 2×2 truth table (2 possible values for each input), yielding 2×2=4 possible entries in the truth table. Each entry in the truth table can take one of two possible values (2 possible values for each output). Thus, there are a total of 2ˆ4=16 possible truth tables that can be implemented. If every truth table is implemented, the truth tables are all unique, and Boolean Func is coded in a straightforward manner, then Boolean Func would require 4 bits to specify which truth table (i.e., which logic function) is being implemented. Correspondingly, the number Boolean Func would equal 4 bits in this example. Note that it is also possible to have Boolean Func of only 5 bits for 4-state logic with modifications to the circuitry.

The multiplexer 304 selects input data from one of the 2n bus lines of the crossbar 101 in response to a selection signal P0 that has P0 bits, and the multiplexer 306 selects input data from one of the 2n bus lines of the crossbar 101 in response to a selection signal P1 that has P1 bits. The PE 302 receives the input data selected by the multiplexers 304, 306 as operands, and performs the simulation according to the configured logic function as indicated by the Boolean Func signal. Note that the choice of a PE 302 with 2 inputs is one implementation, and it is also possible to have a PE with 3 or more inputs.

In the example of FIG. 3, each of the multiplexers 304, 306 for every processor unit 103 can select any of the 2n bus lines. The crossbar 101 is fully non-blocking and exhaustively connective. This is not required in all implementations. For example, some of the processor units 103 may be designed to have more limited connectivity, with possible connection to only some and not all of the other processor units 103, or to only some and not all of the output lines from other processor units 103. Different input lines to the same processor unit may also have different connectivity. For example, multiplexer 304 might be designed to have full connectivity to any of the 2n bus lines, but multiplexer 306 might be designed to have more limited connectivity.

In addition, the selections signals P0 and P1 are represented here as distinct signals, one for selecting the input to multiplexer 304 and one for selecting the input to multiplexer 306. This also is not required. The information for selecting inputs may be combined into a single field (call it P01) or even combined with other fields. For example, this may allow more efficient coding of the instruction, thus reducing the instruction length.

The shift register 308 has a depth of y (has y memory cells), and stores intermediate values generated while the PEs 302 in the simulation processor 100 simulate a large number of gates of the logic design 106 in multiple cycles. Using a shift register 308, rather than a general register has the advantage that no input address signal is needed to select a particular memory cell of the shift register 308. FIG. 3 shows a single shift register 308 of depth y, but alternate embodiments can use more than one shift register. In one approach, a single shift register 308 is reproduced, for example to allow more memory access on the output side. The duplicate shift registers may have different depths. For example, only the top half of the shift register may be reproduced if there is much more activity in the top half (which stores fresher data) than in the bottom half (which stores staler data).

In the embodiment shown in FIG. 3, a multiplexer 310 selects either the output 371-373 of the PE 302 or the last entry 363-364 of the shift register 308 in response to bit en0 of the signal EN, and the first entry of the shift register 308 receives the output 350 of the multiplexer 308. Selection of output 371 allows the output of the PE 302 to be transferred to the shift register 308. Selection of last entry 363 allows the last entry 363 of the shift register 308 to be recirculated to the top of the shift register 308, rather than dropping off the end of the shift register 308 and being lost. In this way, the shift register 308 is refreshed.

The multiplexer 310 is optional and the shift register 308 can receive input data directly from the PE 302 in other embodiments. In addition, although in FIG. 3 the first entry of the shift register 308 is coupled to receive the output 371-373 of the PE 302 through the multiplexer 310, the circuit of FIG. 3 may be modified such that any one of the entries of the shift register 308 can receive the output 371-373 of the PE 302 directly or through the multiplexer 310. There can also be more than one entry point to shift register 308 and/or to additional shift registers.

On the output side of the shift register 308, the multiplexer 312 selects one of the y memory cells of the shift register 308 in response to a selection signal XB0 that has XB0 bits as one output 352 of the shift register 308. Similarly, the multiplexer 314 selects one of the y memory cells of the shift register 308 in response to a selection signal XB1 that has XB1 bits as another output 358 of the shift register 308. Depending on the state of multiplexers 316 and 320, the selected outputs can be routed to the crossbar 101 for consumption by the data inputs of processor units 103.

This particular example shows two shift register outputs 352 and 358, each of which can select from anywhere in the shift register. Alternate embodiments can use different numbers of outputs, different accesses to the shift register (as will be discussed in FIG. 4) and different routings. For example, it is not required that every output from the shift register 308 be routable to the crossbar 101. Some outputs may be strictly routed internally within the processor unit 103. For another example, although the embodiment of FIG. 3 uses one shift register 308 and the output of the shift register 308 is accessed by two multiplexers 312, 314, it is also possible to have two separate shift registers and have each of two separate multiplexers access the output of one of the two separate multiplexers. In such case, the contents of the data stored in the two shift registers would be replicated to be identical. Also, the signals for controlling the two separate multiplexers may have different lengths.

The memory 326 has an input port DI and an output port DO for storing data to permit the shift register 308 to be spilled over due to its limited size. In other words, the data in the shift register 308 may be loaded from and/or stored into the memory 326. The number of intermediate signal values that may be stored is limited by the total size of the memory 326. Since memories 326 are relative inexpensive and fast, this scheme provides a scalable, fast and inexpensive solution for logic simulation.

The memory 326 is addressed by an address signal 377 made up of XB0, XB1 and Xtra Mem. Note that signals XB0 and XB1 were also used as selection signals for multiplexers 312 and 314, respectively. Thus, these bits have different meanings depending on the remainder of the instruction. These bits are shown twice in FIG. 3, once as part of the overall instruction 382 and once 380 to indicate that they are used to address the memory 326.

The input port DI is coupled to receive the output 371-372-374 of the PE 302. Note that an intermediate value calculated by the PE 302 that is transferred to the shift register 308 will drop off the end of the shift register 308 after y shifts (assuming that it is not recirculated). Thus, a viable alternative for intermediate values that will be used eventually but not before y shifts have occurred, is to transfer the value from PE 302 directly to the memory 326, bypassing the shift register 308 entirely (although the value could be simultaneously made available to the crossbar 101 via path 371-372-376-368-362). In a separate data path, values that are transferred to shift register 308 can be subsequently moved to memory 326 by outputting them from the shift register 308 to crossbar 101 (via data path 352-354-356 or 358-360-362) and then re-entering them through a PE 302 to the memory 326. Values that are dropping off the end of shift register 308 can be moved to memory 326 by a similar path 363-370-356.

The output port DO is coupled to the multiplexer 324. The multiplexer 324 selects either the output 371-372-376 of the PE 302 or the output 366 of the memory 326 as its output 368 in response to the complement (˜en0) of bit en0 of the signal EN. In this example, signal EN contains two bits: en0 and en1. The multiplexer 320 selects either the output 368 of the multiplexer 324 or the output 360 of the multiplexer 314 in response to another bit en1 of the signal EN. The multiplexer 316 selects either the output 354 of the multiplexer 312 or the final entry 363, 370 of the shift register 308 in response to another bit en1 of the signal EN. The flip-flops 318, 322 buffer the outputs 356, 362 of the multiplexers 316, 320, respectively, for output to the crossbar 101.

Referring to the instruction 382 shown in FIG. 3, the fields can be generally divided as follows. P0 and P1 determine the inputs from the crossbar to the PE 302. EN is primarily a two-bit opcode that will be discussed in further detail below. Boolean Func determines the logic gate to be implemented by the PE 302. XB0, XB1 and Xtra Mem either determine the outputs of the processor unit to the crossbar 101, or determine the memory address 377 for memory 326. Note that Xtra Mem is not a required bit, and Xtra Mem=0 is also a valid condition.

In one embodiment, four different operation modes (Evaluation, No-Operation, Store, and Load) can be triggered in the processor unit 103 according to the bits en1 and en0 of the signal EN, as shown below in Table 1:

TABLE 1
Op Codes for field EN

| Mode | en1 | en0 |
|---|---|---|
| Evaluation | 0 | 0 |
| No-Op | 0 | 1 |
| Load | 1 | 0 |
| Store | 1 | 1 |

FIGS. 3A-3D are modified circuit diagrams illustrating each of these modes. In these diagrams, non-selected data paths have been deleted in order to more clearly show operation of the processor unit during the mode.

FIG. 3A illustrates an evaluation mode (en1=0 and en0=0) of the simulation processor 100. The primary function of this mode is for the PE 302 to simulate a logic gate (i.e., to receive two inputs and perform a specific logic function on the two inputs to generate an output). The multiplexer selections shown in FIG. 3A are chosen to provide data paths that are likely to be used in connection with a logic gate evaluation. Specifically, (i) bit en0=0 causes the multiplexer 310 to select the output 371-373 of the PE 302, (ii) bit en1=0 causes the multiplexer 316 to select the output 354 of the multiplexer 312 and also causes the multiplexer 320 to select the output 360 of the multiplexer 314, and (iii) XB0 and XB1 are used as inputs to multiplexers 312 and 314 rather than addresses to memory 326.

Therefore, during the evaluation mode, the PE 302 simulates a logic gate based on the input operands output by the multiplexers 304 and 306, stores the intermediate value in the shift register 308, which is eventually output to the crossbar 101 for use by other processor units 103. At the same time, multiplexers 312 and 314 can select entries from the shift register 308 for use as inputs to processor units on the next cycle.

FIG. 3B illustrates a no-operation mode (en1=0 and en0=1) of the simulation processor 100. In this mode, the PE 302 performs no operation. The mode may be useful, for example, if other processor units are evaluation functions based on data from this shift register 308, but this PE is idling. The multiplexer selections are chosen as follows: (i) bit en0=1 causes the multiplexer 310 to select the last entry 363-364 of the shift register 308, (ii) bit en1=0 causes the same selections as in FIG. 3A, and (iii) XB0 and XB1 are used as inputs to multiplexers 312 and 314 rather than addresses to memory 326.

During the no-operation mode, the PE 302 does not simulate any gate, while the shift register 308 is refreshed so that the last entry of the shift register 308 is recirculated to the first entry of the shift register 308. At the same time, data can be read out from the shift register 308 via paths 352-354-356 and 358-360-362.

FIG. 3C illustrates a load mode (en1=1 and en0=0) of the simulation processor 100. The primary function of this mode is to load data from local memory 326. The multiplexer selections are chosen as follows: (i) bit en1=1 causes the multiplexer 320 to select the output 368 of the multiplexer 324, and bit ˜en0=1 causes the multiplexer 324 to select the output 366 of the memory 326, (ii) bit en0=1 causes the multiplexer 310 to select the output 371-373 of the PE 302, (iii) bit en1=1 causes the multiplexer 316 to select the last entry 363-370 of the shift register 308. Also, the local memory 326 is addressed by the memory address signal 317 (fields XB0, XB1 and Xtra Mem) to select a particular memory cell as the memory output 366.

Note that during this mode, data can be loaded from the memory 326 to the crossbar 101 for use by processor units and, at the same time, the PE 302 can perform an evaluation of a logic function and store the result in the shift register 308. In many alternate approaches, evaluation by the PE and load from memory cannot be performed simultaneously, as is the case here. In this example, loading data from local memory 326 does not block operation of the PE 302.

FIG. 3D illustrates a store mode (en1=1 and en0=1) of the simulation processor 100. The primary function of this mode is to store data to local memory 326. In this mode, the local memory 326 is addressed by the memory address signal 377 to select a particular memory cell in which the output data 371-372-374 of the PE 302 is stored. Therefore, during the store mode, the output data 371-372-374 of the PE 302 can be stored into the local memory 326. The multiplexers are configured as follows: (i) bit en1=1 causes the multiplexer 320 to select the output 368 of the multiplexer 324, and bit ˜en0=0 causes the multiplexer 324 to select the output 371-372-376 of the PE 302, (ii) bit en1=1 also causes the multiplexer 316 to select the last entry 363-370 of the shift register 308, and (iii) bit en0=1 causes the multiplexer 310 to select the last entry 363-364 of the shift register 308.

The store mode is also non-blocking of the operation of the PE 302. The PE 302 can evaluation a logic function and the resulting value can be immediately stored to local memory 326. It can also be made available to the crossbar 101 via path 371-372-376-368-362. The last entry in the shift register 308 can also be recirculated and also made available to the crossbar via path 370-356.

One advantage of the architecture shown in FIG. 3 is that the load and store modes do not block operation of the PE 302. That is, the load mode might be more appropriately referred to as a load-and-evaluation mode, and the store mode might be more appropriately referred to as a store-and-evaluation mode. This is important for logic simulation. Logic simulation requires the simulation of a certain number of gates. Hence, the more quickly evaluations can be performed, the faster the logic simulation can be completed. Supporting load/store and evaluation in a single cycle is a significant speedup compared to approaches in which load/store requires one cycle and evaluation requires a separate cycle.

FIG. 4 illustrates a single processor unit 103 of the simulation processor in the hardware accelerated logic simulation system according to a second embodiment of the present invention. Each processor unit 103 includes a processor element (PE) 302, a shift register 308, a memory 326, multiplexers 304, 306, 310, 312′, 314′, 316, 320, 324, 386 and flip flops 318, 322. The processor unit 103 is controlled by instructions 383, which have fields P0, P1, Boolean Func, EN, XB0′, XB1′ (XB1′=XB0′+1), and Xtra Mem (optional). A crossbar 101 interconnects each of the processor units 103. The crossbar 101 has 2n bus lines, if the number of PEs 302 or processor units 103 in the simulation processor 100 is n and each processor unit has two inputs and two outputs to the crossbar.

The processor unit shown in FIG. 4 is the same as the one shown in FIG. 3, with one significant difference. In FIG. 3, multiplexer 312 could select any of they entries in shift register 308, as could multiplexer 314. In FIG. 4, while multiplexer 314′ can select any of they entries in shift register 308, multiplexer 312′ can only select from the top half of the shift register. Multiplexer 312′ can address only y/2 entries.

In more detail, the multiplexer 386 selects either the mid-entry (y/2) 388 or the last entry (y) 390 of the shift register 308 in response to bit en1, although the multiplexer 386 can be modified to select any two entries of the shift register 308 in other embodiments. The output 363 of multiplexer 386 plays a role similar to signal 363 in FIG. 3. Thus, multiplexer 310 selects either the output 371-373 of the PE 302 or the output 363-364 of multiplexer 368 in response to bit en0, and the first entry of the shift register 308 receives the output 350 of the multiplexer 310. Additionally, the multiplexer 312′ selects one of the memory cells (0 through y/2) of the shift register 308 in response to a selection signal XB0′, and the multiplexer 314′ selects one of they memory cells of the shift register 308 in response to a selection signal XB1′. The memory 326 is addressed by an address signal 377 that includes the bits XB0′, XB1′.

This approach shown in FIG. 4 may result in better utilization of the fields XB0′, XB1′. For example, referring first to FIG. 3, assume that y is a power of 2 and XB0=XB1=log (base 2) y. Further assume that Xtra Mem has 1 bit, so Xtra Mem=1 and there are 2ˆ(2 XB0+1) possible addresses for the local memory. Now consider a design for FIG. 4 which uses the same size local memory but a shift register with depth 2y instead of y. Use prime to indicate the quantities for FIG. 4. Then, XB0′=XB0 because multiplexer 312′ only addresses half of the shift register so the same number of bits are needed as in FIG. 3 to address the entire shift register. However, XB1′=XB1+1 since multiplexer 314′ addresses twice as many shift register entries. Accordingly, the Xtra Mem field is not needed in FIG. 4. Instead of using fields XB0, XB1 and Xtra Mem of FIG. 3, fields XB0′ and XB1′ can be used in FIG. 4. Thus, FIG. 4 results in an instruction that has the same length as FIG. 3 (i.e., no additional bits are needed), a local memory of the same size but a shift register with twice the depth. This is achieved by utilizing the bits in the Xtra Mem field for shift register addressing in addition to local memory addressing. In FIG. 3, these bits were used only for local memory addressing and were wasted during shift register addressing.

The multiplexer 386 selects either the mid-entry 388 or the last entry 390 during various modes. In the example of FIG. 4, the multiplexer 386 is configured so that the shift register 308 is refreshed by recirculating the mid-entry 388 to the top of the shift register 308 in the no-operation mode (en1=0 and en0=1) via path 388-363-364-350, the last entry 390 is output to the crossbar 101 during the load mode (en1=1 and en0=0) via path 390-363-370-356, and the last entry 390 is both recirculated to the top of the shift register 308 and output to the crossbar 101 during the store mode (en1=1 and en0=1).

If one more bit is added to the instruction register, it can be used to augment the embodiment of FIG. 4 back into the embodiment of FIG. 3, resulting in that the instruction register depth becomes 2y. This enables the shift register 308 to hold more data which is useful as the proposed architecture will cause data to be interleaved during operation.

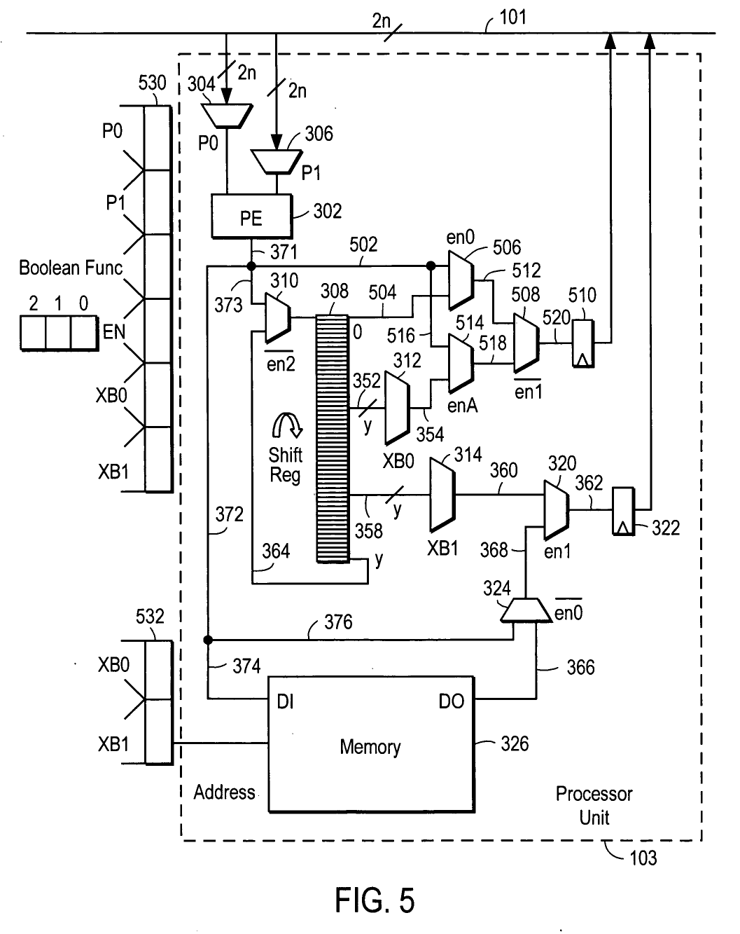

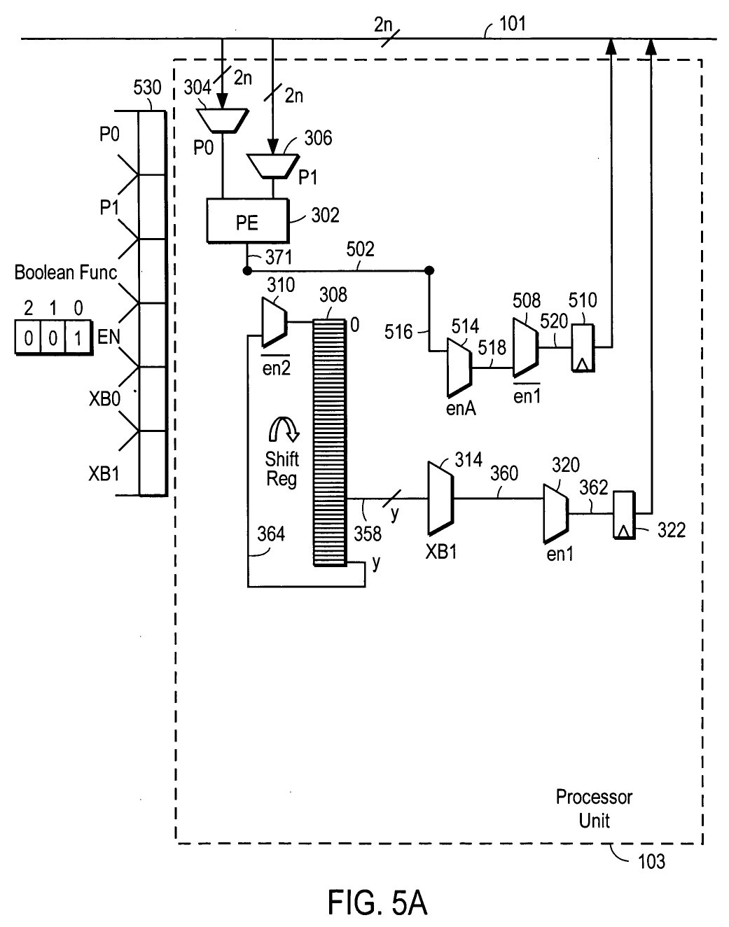

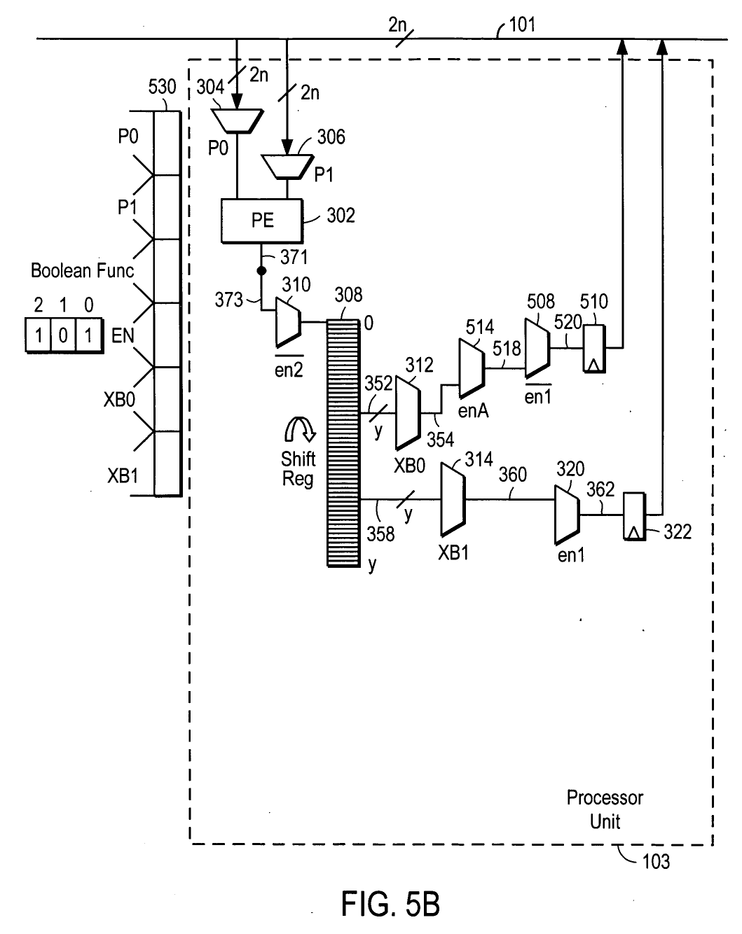

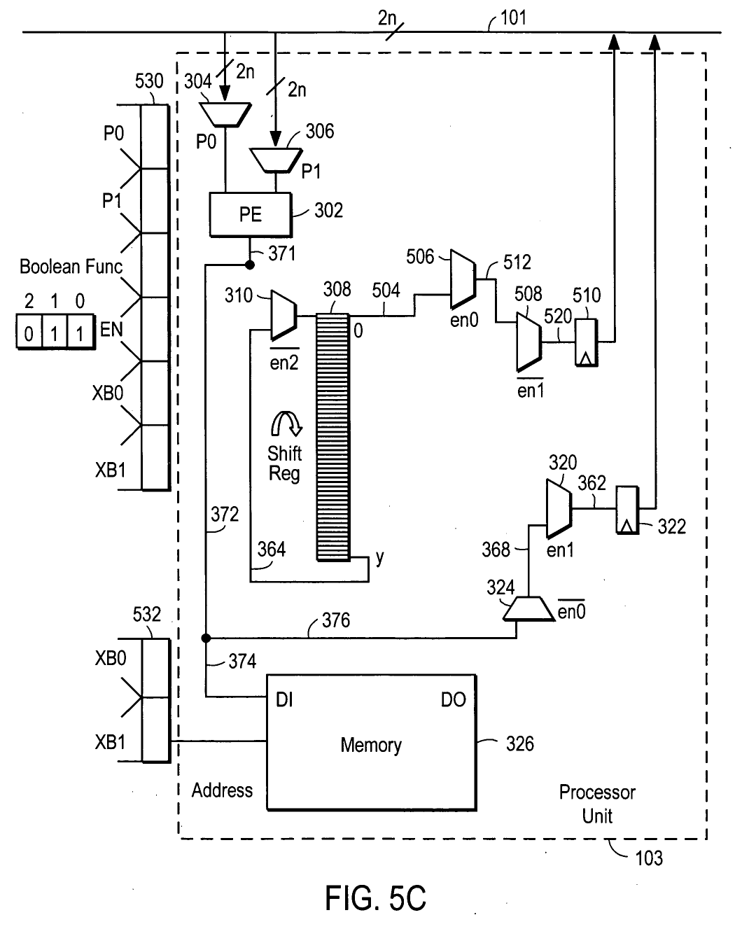

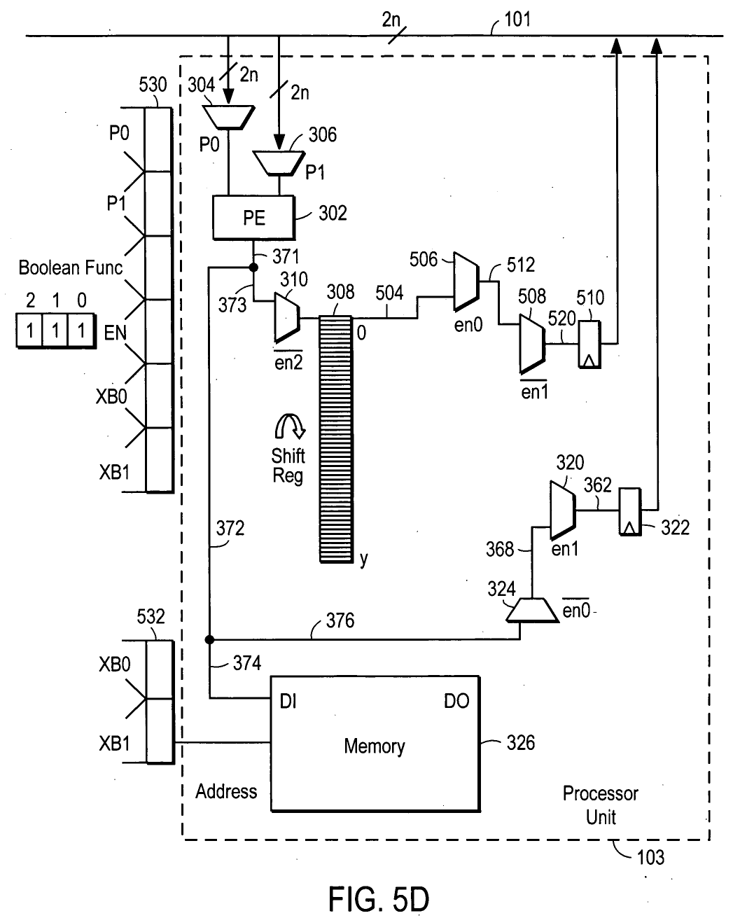

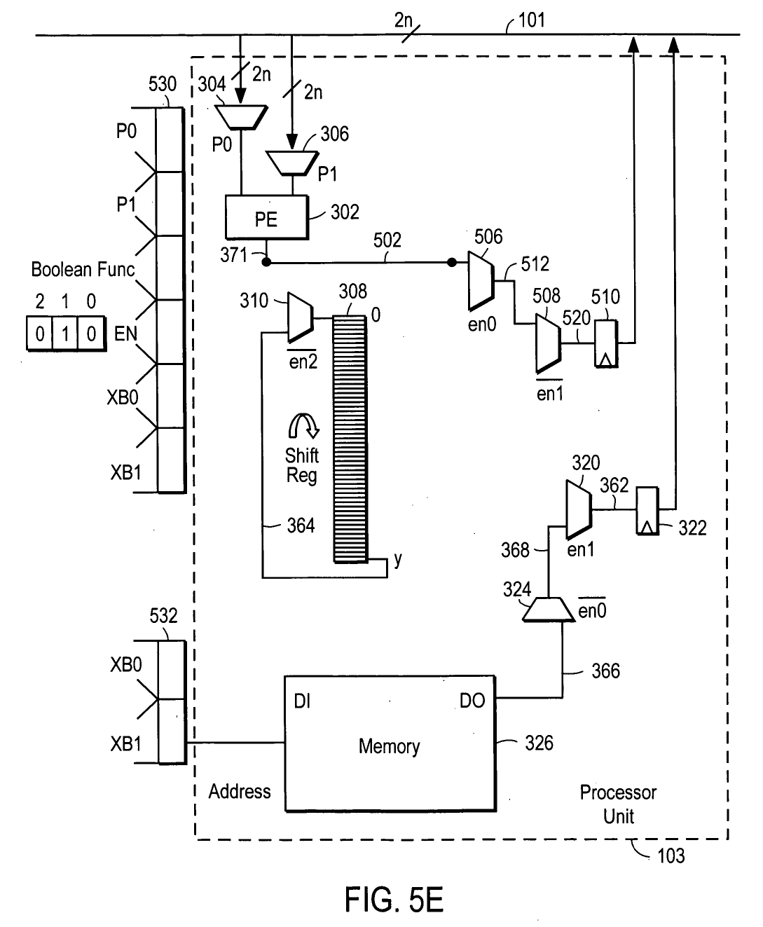

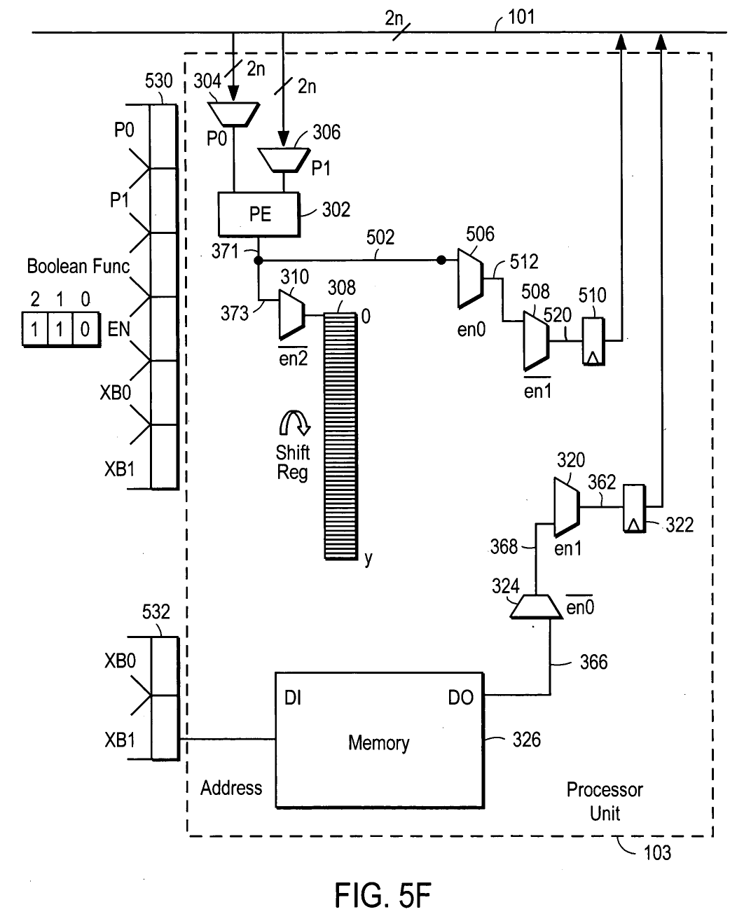

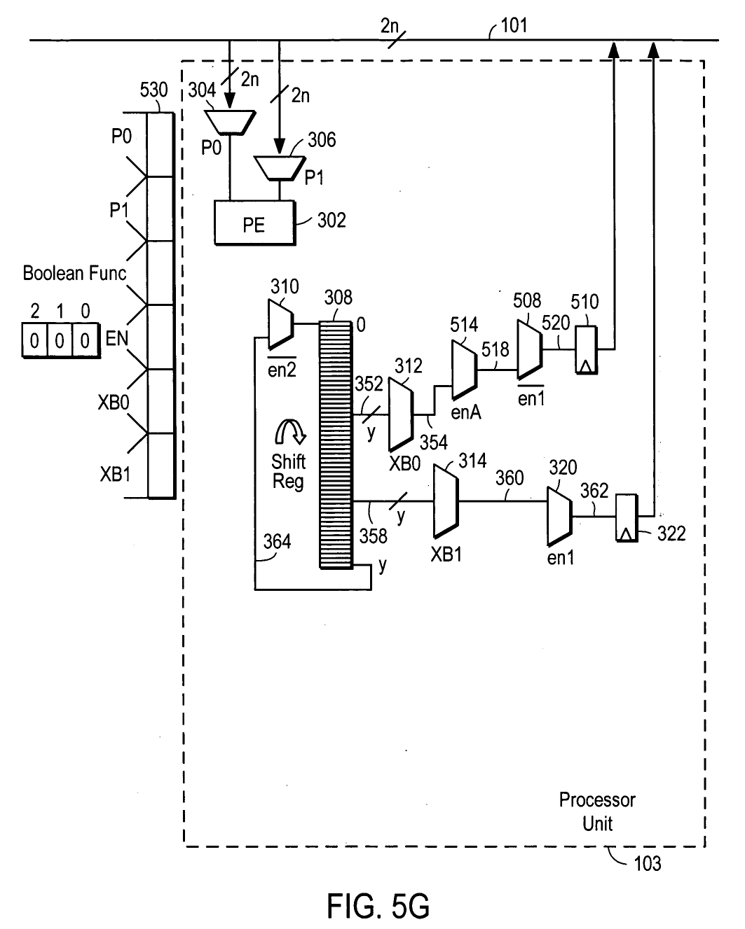

Another example of using this same bit is to add it to steering control inside the processor unit, which can mitigate the required depth of the local shift register 308, caused by data interleaving. Rather than using an extra programming bit in the instruction register to augment the embodiment of FIG. 3 to the embodiment of FIG. 4, the bit can be used for steering to augment the embodiment of FIG. 3 to result in the embodiment of FIG. 5. In the embodiment of FIG. 5, the four Op Codes from Table 1 now become eight Op Codes as shown below in Table 2:

TABLE 2
Op Codes for field EN

| Mode | en2 | en1 | en0 |
|---|---|---|---|
| Evaluation-0 | 0 | 0 | 1 |
| Evaluation-1 | 1 | 0 | 1 |
| No-Op-0 | 0 | 0 | 0 |
| No-Op-1 | Undefined (Not Used) | | |
| Load-0 | 0 | 1 | 0 |
| Load-1 | 1 | 1 | 0 |
| Store-0 | 0 | 1 | 1 |
| Store-1 | 1 | 1 | 1 |

Bit en2 is added and is used to create a more versatile data steering approach. Table 2 above shows a possible mapping. The embodiment of FIG. 3 is now enhanced using the bit en2 to result in the embodiment of FIG. 5. First the data interleaving problem inherent to the embodiment of FIG. 3 is explained. As the PE output 371 is stored in the shift register 308 it is not available for processing until the next cycle. Because for the outputs 352, 358 of the shift register 308 is used to connect to the crossbar 101, there is a one cycle latency created, i.e., the PE output 371 is stored into the shift register 308 at time point T, and it cannot be returned to the crossbar 101 until time point T+2. Therefore, at timepoint T+1 other logic should be computed. This is referred to as data interleaving herein. This data interleaving requires that the shift register 308 is larger.

By allowing a bypass mode of the shift register, the data interleaving problem can be mitigated. In the embodiment of FIG. 5, a direct steering control method uses the bit values of en0, en1 and en2 as they are encoded in Table 2. This is merely for purposes of illustration. It is possible to design more complicated control methods using the same Op Codes to control more than the 3 control bits (en0, en1 and en2) shown herein.

FIG. 5 is a circuit diagram illustrating a single processor unit of the simulation processor according to a third embodiment of the present invention. The processor unit shown in FIG. 5 is the same as the one shown in FIG. 3, with a few significant differences. As compared to the processor unit in FIG. 3, the processor unit of FIG. 5 additionally includes multiplexers 506, 514, 508, and the EN signal of the instruction word 530 has three bits (en0, en1, en2) for defining the operation modes. An additional enable signal enA is included and is derived from en0 and en2 using the following formula: enA=en0*en2+˜en0*˜en2. Also note that the memory 326 is addressed by the address 532 comprised of only XB0 and XB1, without the Xtra Mem bit, for simplicity in the drawings. Also, in FIGS. 5, 5A through 5F, the relevant multiplexers are shown such that if the corresponding control bit value is 0, the uppermost or leftmost input is selected, and if the corresponding control bit value is 1, the lowermost or rightmost input is selected.

The multiplexer 506 selects either the output 371-502 of the PE 302 or the first entry 504 of the shift register 308 in response to bit en0. The multiplexer 514 selects either the output 371-502-516 of the PE 302 or the output 354 of the multiplexer 312 in response to bit enA. The multiplexer 508 selects either the output 512 of the multiplexer 506 or the output 518 of the multiplexer 514 in response to bit ˜en1. The output 520 of the multiplexer 508 is input to the flip flop 510. The multiplexer 324 selects either the output 371-372-376 of the PE 302 or the output 366 from the memory 326 in response to ˜en0. The multiplexer 320 selects either the output 360 of the multiplexer 314 or the output 368 of the multiplexer 324 in response to en1. The output 362 of the multiplexer 320 is input to the flip flop 322.

The multiplexers 506, 514, 508, 324, 320 provide a path for the output 371 of the PE 302 to bypass the shift register 308 and be fed directly to the crossbar 101. This enables the simulation processor of FIG. 5 to perform the simulation in one less cycle compared to the simulation processor of FIG. 3 because one cycle for accessing the shift register 308 can be eliminated when the shift register 308 is bypassed. In addition, this allows for streamlined data processing rather than interleaved data processing.

FIGS. 5A-5G are modified circuit diagrams of FIG. 5 illustrating each of the modes listed in Table 2. In these diagrams, non-selected data paths have been deleted in order to more clearly show operation of the processor unit during the mode.

FIG. 5A is a modified circuit diagram of the processor unit of FIG. 5, illustrating a first type (Evaluation-0) of evaluation mode (en2=0, en1=0, and en0=1) for the processor unit. In this mode, the multiplexer selections shown in FIG. 5A are chosen to provide data paths that are likely to be used in connection with a logic operation evaluation and also for the output 371 of the PE 302 to bypass the shift register 308. Specifically, (i) bit ˜en2=1 causes the multiplexer 310 to select the last entry 364 of the shift register, (ii) bit enA=0 causes the multiplexer 514 to select the output 371-502-516 of the PE 302, (iii) bit en1=1 causes the multiplexer 508 to select the output 518 of the multiplexer 514, (iv) bit en1=0 causes the multiplexer 320 to select the output 360 of the multiplexer 314, and (v) XB1 is used as an input to multiplexer 314 rather than an address to memory 326. Therefore, during the first type (Evaluation-0) of the evaluation mode, the PE 302 simulates a logic operation based on the input operands output by the multiplexers 304 and 306, and the intermediate value 371 output by the PE 302 bypasses the shift register 308 to be fed into the multiplexer 514, which is eventually output to the crossbar 101 for use by other processor units 103. At the same time, the multiplexer 314 can select an entry from the shift register 308 for use as an input to processor units on the next cycle.

FIG. 5B is a modified circuit diagram of the processor unit of FIG. 5, illustrating a second type (Evaluation-1) of evaluation mode evaluation mode (en2=1, en1=0, and en0=1) for the processor unit. In this mode, the multiplexer selections shown in FIG. 5B are chosen to provide data paths that are likely to be used in connection with a logic gate evaluation and also for the output 371 of the PE 302 to be stored in the shift register 308. Specifically, (i) bit ˜e2=0 causes the multiplexer 310 to select the output 371-373 of the PE 302, (ii) bit enA=1 causes the multiplexer 514 to select the output 354 of the multiplexer 312, (iii) bit ˜en1=1 causes the multiplexer 508 to select the output 518 of the multiplexer 514, (iv) bit en1=0 causes the multiplexer 320 to select the output 360 of the multiplexer 314 and (v) XB0, XB1 are used as inputs to multiplexers 312, 314 rather than addresses to memory 326. Therefore, during the second type (Evaluation-1) of the evaluation mode, the PE 302 simulates a logic operation based on the input operands output by the multiplexers 304 and 306, and the intermediate value 371 output by the PE 302 is stored in the shift register 308. At the same time, multiplexers 312, 314 can select entries from the shift register 308 for use as inputs to processor units on the next cycle.

FIG. 5C is a modified circuit diagram of the processor unit of FIG. 5, illustrating a first type (Store-0) of store mode (en2=0, en1=1, and en0=1) for the processor unit. The primary function of this mode is to store data to local memory 326 while refreshing the first entry of the shift register 308 with the last entry 364 of the shift register 308. In this mode, the local memory 326 is addressed by the memory address signal 532 comprised of XB0 and XB1 to select a particular memory cell in which the output data 371-372-374 of the PE 302 is stored. Therefore, during the store mode, the output data 371-372-374 of the PE 302 can be stored into the local memory 326. The multiplexers are configured as follows: (i) bit ˜en2=1 causes the multiplexer 310 to select the last entry 364 of the shift register 308, (ii) bit en0=1 causes the multiplexer 506 to select the first entry 504 of the shift register 308, (iii) bit en1=0 causes the multiplexer 508 to select the output 512 of the multiplexer 506, (iv) bit en0=0 causes the multiplexer 324 to select the output 371-372-376 of the PE 302, and (v) bit en1=1 causes the multiplexer 320 to select the output 368 of the multiplexer 324.

FIG. 5D is a modified circuit diagram of the processor unit of FIG. 5, illustrating a second type (Store-1) of store mode (en2=1, en1=1, and en0=1) for the processor unit. The primary function of this mode is to store data to local memory 326 while storing the intermediate value output 371-373 by the PE 302 to the shift register 308. In this mode, the local memory 326 is addressed by the memory address signal 532 comprised of XB0 and XB1 to select a particular memory cell in which the output data 371-372-374 of the PE 302 is stored. Therefore, during the store mode, the output data 371-372-374 of the PE 302 can be stored into the local memory 326. The multiplexers are configured as follows: (i) bit ˜en2=0 causes the multiplexer 310 to select the output 371-373 of the PE 302, (ii) bit en0=1 causes the multiplexer 506 to select the first entry 504 of the shift register 308, (iii) bit ˜en1=0 causes the multiplexer 508 to select the output 512 of the multiplexer 506, (iv) bit ˜en0=0 causes the multiplexer 324 to select the output 371-372-376 of the PE 302, and (v) bit en1=1 causes the multiplexer 320 to select the output 368 of the multiplexer 324.

The store modes of FIGS. 5C and 5D are non-blocking of the operation of the PE 302. In other words, the PE 302 can evaluate a logic function and the resulting value can be immediately stored to local memory 326. It can also be made available to the crossbar 101 via path 371-372-376-368-362 or via 371-373-504-512-520. Note that the data 374 and address 532 can change at the same time. As an enhancement, in the preferred embodiment, we opted for registering the data 374 in one instruction, and allowing for sending the address 532 (XB0, XB1) to the memory 326 in the following instruction. As a result, the data 374, required for storage, must be produced one compute cycle earlier than the address 532 for storage itself. In this context, the non-blocking operation applies to two consecutive steps, the PE-output as a logic function in the first cycle and the usage of the XB0 and XB1 registers in the second cycle to select address 532. The PE-output in the second cycle is available on register 322 in both modes shown on FIGS. 5C and 5D. In FIG. 5C (EN=011) the shift-register 308 is refreshed, whereas in FIG. 5D (EN=111) the PE-output is stored in the shift-register 308, as its first entry.

FIG. 5E is a modified circuit diagram of the processor unit of FIG. 5, illustrating a first type (Load-0) of load mode (en2=0, en1=1, en0=0) for the processor unit. The primary function of this mode is to load data from local memory 326 while refreshing the first entry of the shift register 308 with the last entry 364 of the shift register 308. The multiplexer selections are: (i) bit ˜en2=1 causes the multiplexer 310 to select the last entry 364 of the shift register 308, (ii) bit en0=0 causes the multiplexer 506 to select the output 371-502 of the PE 302, (iii) bit ˜en1=0 causes the multiplexer 508 to select the output 512 of the multiplexer 506, (iv) bit ˜en0=1 causes the multiplexer 324 to select the output 366 of the memory 326, and (v) en1=1 causes the multiplexer 320 to select the output 368 of the multiplexer 324. Also, the local memory 326 is addressed by the memory address signal 532 (fields XB0, XB1) to select a particular memory cell as the memory output 366.

FIG. 5F is a modified circuit diagram of the processor unit of FIG. 5, illustrating a second type (Load-1) of load mode (en2=1, en1=1, en0=0) for the processor unit. The primary function of this mode is to load data from local memory 326 while storing the intermediate value output 371-373 by the PE 302 to the shift register 308. The multiplexer selections are as follows: (i) bit en2=0 causes the multiplexer 310 to select the output 371-373 of the PE 302, (ii) bit en0=0 causes the multiplexer 506 to select the output 371-502 of the PE 302, (iii) bit ˜en1=0 causes the multiplexer 508 to select the output 512 of the multiplexer 506, (iv) bit ˜en0=1 causes the multiplexer 324 to select the output 366 of the memory 326, and (v) en1=1 causes the multiplexer 320 to select the output 368 of the multiplexer 324. Also, the local memory 326 is addressed by the memory address signal 532 (fields XB0, XB1) to select a particular memory cell as the memory output 366.

Note that during the load modes of FIGS. 5E and 5F, data can be loaded from the memory 326 to the crossbar 101 for use by processor units and, at the same time, the PE 302 can perform an evaluation of a logic operation and store the result in the shift register 308 or bypass the shift register 308. Therefore, loading data from local memory 326 does not the block operation of the PE 302.

FIG. 5G is a modified circuit diagram of the processor unit of FIG. 5, illustrating a first type (No-Op-0) of no-operation mode (en2=0, en1=0, en0=0) for the processor unit. In this mode, the PE 302 performs no operation. The mode may be useful, for example, if other processor units are evaluating functions based on data from this shift register 308, but this PE 302 is idling. The multiplexer selections are as follows: (i) bit ˜en2=1 causes the multiplexer 310 to select the last entry 364 of the shift register 308, (ii) bit enA=1 causes the multiplexer 514 to select the output 354 of the multiplexer 312, (iii) bit ˜en1=1 causes the multiplexer 508 to select the output 518 of the multiplexer 514, and (iv) bit en1=0 causes the multiplexer 320 to select the output 360 of the multiplexer 314. Note that XB0 and XB1 are used as inputs to multiplexers 312 and 314 rather than addresses to the memory 326. During the no-operation mode, the PE 302 does not simulate any logic operation, while the shift register 308 is refreshed so that the last entry 364 of the shift register 308 is recirculated to the first entry of the shift register 308. At the same time, data can be read out from the shift register 308 via paths 352-354-518-520 and 358-360-362. Note that the second no-operation mode (en2=1, en1=0, en0=0) is undefined and not used.

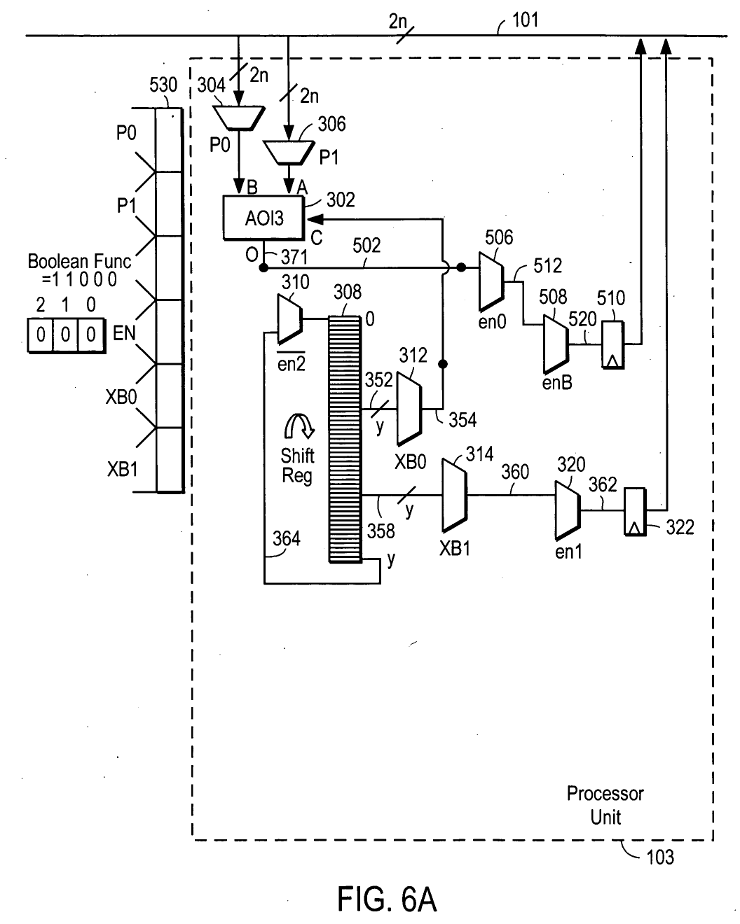

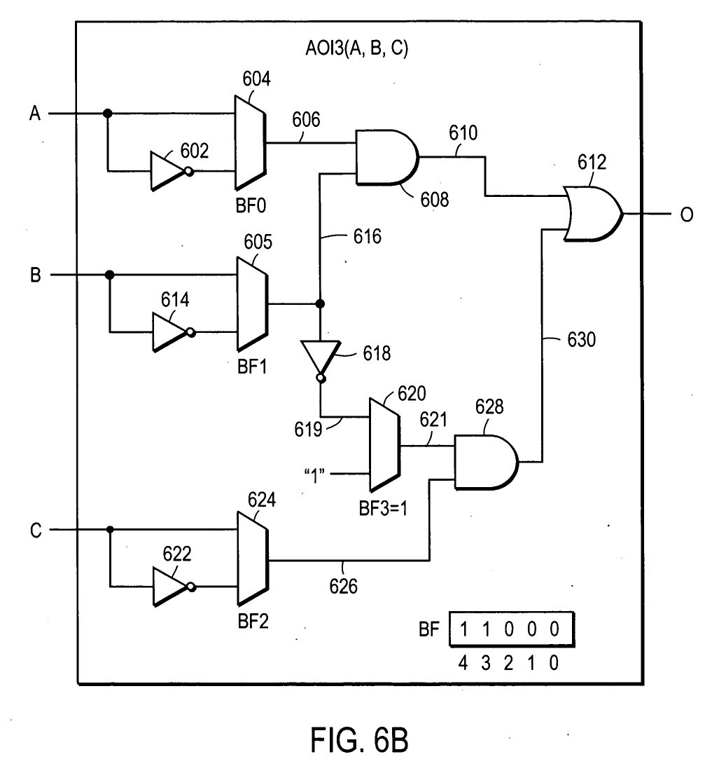

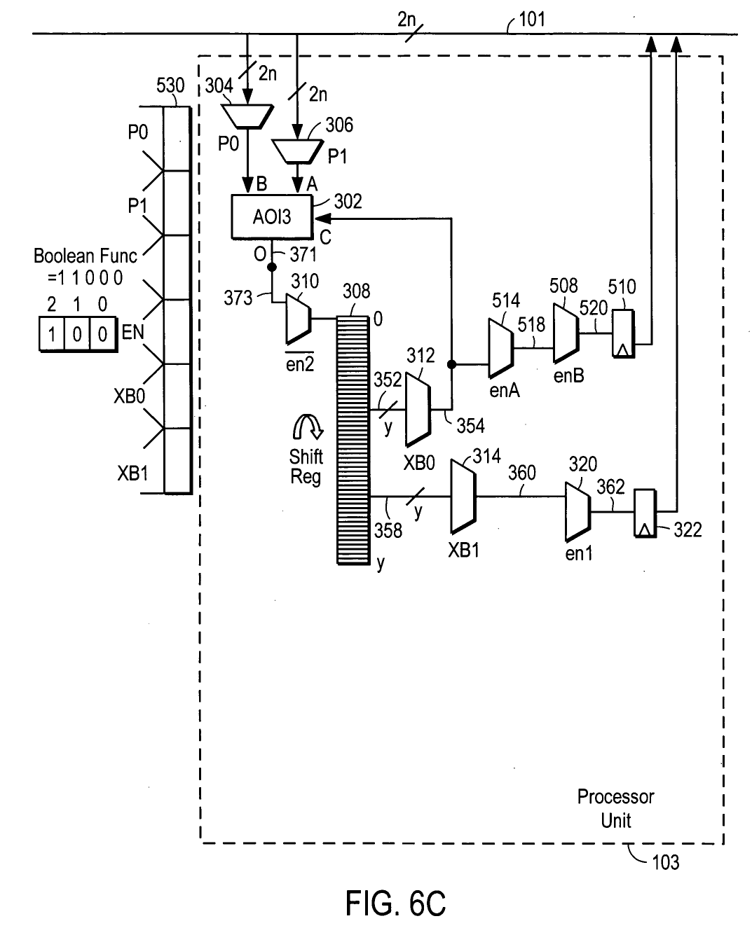

FIG. 6A illustrates a single processor unit of the simulation processor according to a fourth embodiment of the present invention, where the processor element performs an AOI3 function in a first type (NOOP-AOI3-0) of no-operation mode (en2=0, en1=0, en0=0, and Boolean Func=11000 (BF4, BF3, BF2, BF1, BF0)). The processor unit shown in FIG. 6A is the same as the processor unit of FIG. 5, except that the PE 302 receives the output 354 of the multiplexer 312 as an input to the PE 302 and that the PE 302 is configured to simulate an AOI3 function. Additionally, the signal ˜en1 that controls multiplexer 508 is replaced by signal enB. Signal enB can be expressed using the formula: enB=BF4*en2*˜en1*˜en0+en1. If the EN code is anything but the No-Op-0 (en2=0, en1=0, en0=0) or No-Op-1 (en2=1, en1=0, en0=0), the multiplexer 508 is effectively controlled by the en1 signal, similar to the previous FIGS. 5A thru 5G. If the EN signal is either No-Op-0 (en2=0, en1=0, en0=0) or No-Op-1 (en2=1, en1=0, en0=0), the multiplexer 508 is controlled by signal BF4*en2. We make use of this feature in selecting whether the PE-output 371-502 (en2=0) can be made available to the crossbar 101 or the output 354 of the multiplexer 312 (en2=1). We will show this in the diagrams. No-Op-1 was an invalid operation in the circuit of FIG. 5, because the PE 302 is not performing an operation. Because in FIG. 6 the PE 302 is now performing an operation in the No-Op-1 mode, this is now a valid operation. Note that non-selected data paths have been deleted in order to more clearly show operation of the processor unit during the mode, although they exist as illustrated in FIG. 5. The AOI3 function that the PE 302 is configured to execute is described below in more detail with reference to FIG. 6B. The multiplexer selections are as follows: (i) ˜en2=1 causes the multiplexer 310 to select the last entry 364 of the shift register 308, (ii) en0=0 causes the multiplexer 506 to select the output (O) 371-502 of the PE (AOI3) 302, (iii) enB=0 causes the multiplexer 508 to select the output 512 of the multiplexer 506, and (iv) en1=0 causes the multiplexer 320 to select the output 360 of the multiplexer 314. Note that the output 354 of the multiplexer 312 is fed into the PE (AOI3) 302 as an input (C). Note that the output 371-502 of the PE (AIO3) 302 bypasses the shift register 308.

FIG. 6B is a circuit diagram illustrating the AOI3 function of the processor element in detail. The AOI3 logic includes three inputs A, B, C and one output O. The output O can be expressed as O=A*B+C. The AOI3 logic comprises inverters 602, 614, 622, 618, multiplexers 604, 605, 624, 620, AND gates 608, 628, and an OR gate 612. The PE 302 is configured to perform the AOI3 function when the EN code is either No-OP-0 or No-Op-1 and the Boolean Func (BF)=11xxx (BF4, BF3, BF2, BF1, BF0), i.e., BF4=1 and BF3=1. Bits BF2, BF1, and BF0 are used to control whether the inputs should come in as they are or whether they should be inverted. The inverter 602 receives input A and outputs ˜A. The inverter 614 receives input B and outputs ˜B. The inverter 622 receives input C and outputs ˜C. The inverter 618 receives the output 616 of multiplexer 605 and outputs 619 an inverse thereof. The multiplexer 604 selects either A in response to BF0=0 or ˜A in response to BF0=1. The multiplexer 605 selects either B in response to BF1=0 or ˜B in response to BF1=1. The multiplexer 624 selects either C in response to BF2=0 or ˜C in response to BF2=1. The multiplexer 620 selects either the output 619 of the inverter 618 when BF3=0 or “1” when BF3=1. Here, BF3=1, so the multiplexer 620 selects “1.” The AND gate 608 receives the output 606 of multiplexer 604 and the output 616 of the multiplexer 605, and generates an AND'ed output 610. The AND gate 628 receives the output 621 of the multiplexer 620 and the output 626 of the multiplexer 624, and generates an AND'ed output 630. The OR gate 612 receives the output 610 of the AND gate 608 and the output 630 of the AND gate 628 and generates an OR'ed output O. By selecting BF3=1, the AOI3 function O=A*B+C has been created. All input variations (A, ˜A, B, ˜B, C, ˜C) are available under control of BF2, BF1, and BF0.

A truth table illustrating the AOI3 function is shown in Table 3 below:

TABLE 3
AOI3

| A | B | C | O |
|---|---|---|---|
| 0 | 0 | 0 | 0 |
| 0 | 0 | 1 | 1 |
| 0 | 1 | 0 | 0 |
| 0 | 1 | 1 | 1 |
| 1 | 0 | 0 | 0 |
| 1 | 0 | 1 | 1 |
| 1 | 1 | 0 | 1 |
| 1 | 1 | 1 | 1 |

FIG. 6C is a circuit diagram illustrating a single processor unit of the simulation processor according to the fourth embodiment of the present invention, where the processor element performs an AOI3 function in a second type (NOOP-AOI3-1) of no-operation mode (en2=1, en10, en0=0, and the Boolean Func=11000). The processor unit shown in FIG. 6C is the same as the processor unit of FIG. 5, except that the PE 302 receives the output 354 of the multiplexer 312 as an input to the PE 302 and that the PE 302 is configured to simulate an AIO3 function. Note that non-selected data paths have been deleted in order to more clearly show operation of the processor unit during the mode, although they exist as illustrated in FIG. 5. The AOI3 function that the PE 302 is configured to execute is described above in more detail with reference to FIG. 6B. Additionally, the variable enA is now under control of BF4 as well: the formula enA=en0*en2+˜en0*˜en2 is changed to enA=˜BF4*(en0*en2+˜en0*˜en2)+BF4*en2. The multiplexer selections are as follows: (i) ˜en2=0 causes the multiplexer 310 to select the output 371-373 of the PE (AOIE) 302, (ii) enA=1 causes the multiplexer 514 to select the output 354 of the multiplexer 312, (iii) enB=1 causes the multiplexer 508 to select the output 518 of the multiplexer 514, and (iv) en1=0 causes the multiplexer 320 to select the output 360 of the multiplexer 314. Note that the output 354 of the multiplexer 312 is fed into the PE (AOI3) 302 as an input (C). Note that the output 371-373 of the PE (AIO3) 302 does not bypass the shift register 308 in this mode bus is fed into the shift register 308.

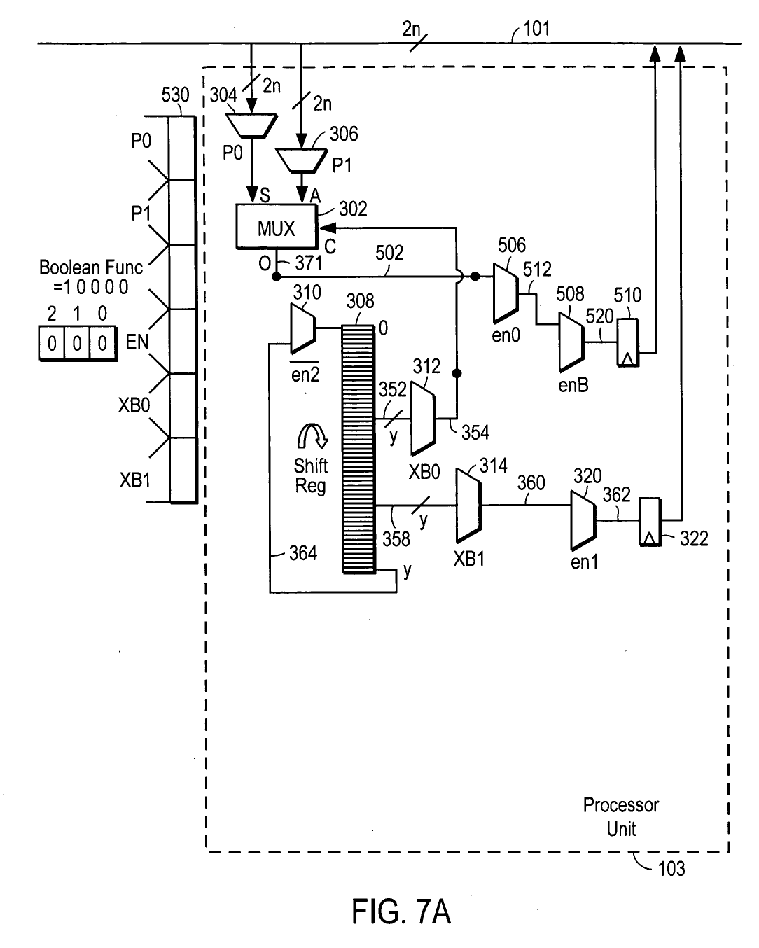

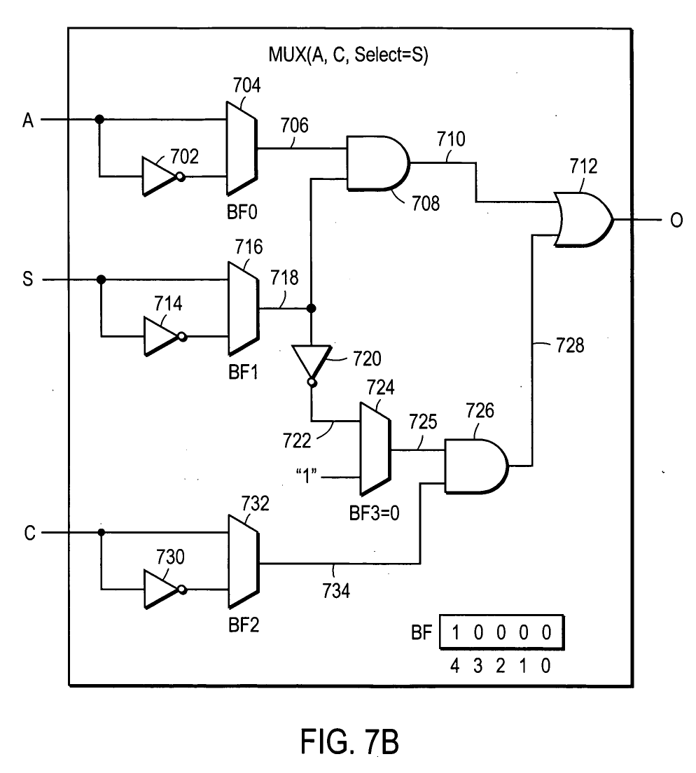

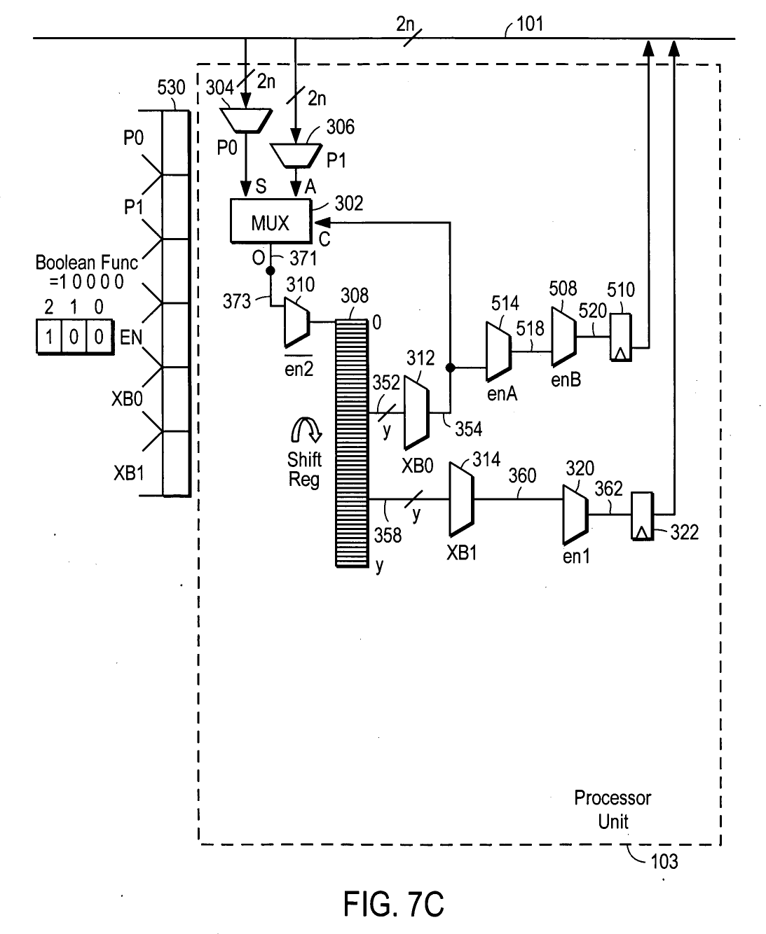

FIG. 7A is a circuit diagram illustrating a single processor unit of the simulation processor according to the fifth embodiment of the present invention, where the processor element performs a multiplexer (MUX) function in a first type (NOOP-MUX-0) of no-operation mode (en2=0, en1=0, en0=0, and the Boolean Func=10000). The processor unit shown in FIG. 7A is the same as the processor unit of FIG. 5, except that the PE 302 receives the output 354 of the multiplexer 312 as an input to the PE 302 and that the PE 302 is configured to simulate a MUX function. Note that non-selected data paths have been deleted in order to more clearly show the operation of the processor unit during the mode, although they exist as illustrated in FIG. 5. The MUX function that the PE 302 is configured to execute is described below in more detail with reference to FIG. 7B. In this mode, the multiplexer selections are as follows: (i) ˜en2=1 causes the multiplexer 310 to select the last entry 364 of the shift register 308, (ii) en0=0 causes the multiplexer 506 to select the output (O) 371-502 of the PE (MUX) 302, (iii) enB=0 causes the multiplexer 508 to select the output 512 of the multiplexer 506, and (iv) en1=0 causes the multiplexer 320 to select the output 360 of the multiplexer 314. Also note that the output 354 of the multiplexer 312 is fed into the PE (MUX) 302 as an input (C). Note that the output 371-502 of the PE (MUX) 302 bypasses the shift register 308 in this mode.

FIG. 7B is a circuit diagram illustrating the MUX function of the processor element in detail. The MUX logic includes three inputs A, S, C and one output O. The MUX logic comprises inverters 702, 714, 730, 720, multiplexers 704, 716, 732, 724, AND gates 708, 726, and an OR gate 712. The PE 302 is configured to perform the MUX function when the Boolean Func (BF)=10xxx (BF4, BF3, BF2, BF1, BF0), i.e., BF4=1 and BF3=0. Bits BF2, BF1, and BF0 are used to control whether the inputs should come in as they are, or whether they should be inverted.

The inverter 702 receives input A and outputs ˜A. The inverter 714 receives input S and outputs ˜S. The inverter 730 receives input C and outputs ˜C. The inverter 720 receives the output 718 of multiplexer 716 and outputs 722 an inverse thereof. The multiplexer 704 selects either A in response to BF0=0 or ˜A in response to BF0=1. The multiplexer 716 selects either S in response to BF1=0 or ˜S in response to BF1=1. The multiplexer 732 selects either C in response to BF2=0 or ˜C in response to BF2=1. The multiplexer 724 selects either the output 722 of the inverter 720 when BF3=0 or “1” when BF3=1. Here, BF3=0, so the multiplexer 724 selects the output 722 of the inverter 720. The AND gate 708 receives the output 706 of multiplexer 704 and the output 718 of the multiplexer 716, and generates an AND'ed output 710. The AND gate 726 receives the output 725 of the multiplexer 724 and the output 734 of the multiplexer 732, and generates an AND'ed output 728. The OR gate 712 receives the output 710 of the AND gate 708 and the output 728 of the AND gate 726 and generates an OR'ed output O. By selecting BF3=0, the MUX function O=S*A+˜S*B has been created. All input variations (A, ˜A, B, ˜B, S, ˜S) are available under control of BF2, BF1, and BF0.

A truth table illustrating the MUX function is shown in Table 4 below:

TABLE 4
MUX

| S | A | C | O |
|---|---|---|---|
| 0 | 0 | 0 | 0 |
| 0 | 0 | 1 | 1 |
| 0 | 1 | 0 | 0 |
| 0 | 1 | 1 | 1 |
| 1 | 0 | 0 | 0 |
| 1 | 0 | 1 | 0 |
| 1 | 1 | 0 | 1 |
| 1 | 1 | 1 | 1 |

FIG. 7C is a circuit diagram illustrating a single processor unit of the simulation processor according to the fifth embodiment of the present invention, where the processor element performs a MUX function in a second type (NOOP-MUX-1) of no-operation mode (en2=1, en1=0, en0=0, and the Boolean Func=10000). The processor unit shown in FIG. 7C is the same as the processor unit of FIG. 5, except that the PE 302 receives the output 354 of the multiplexer 312 as an input to the PE 302 and that the PE 302 is configured to simulate a MUX function. Note that non-selected data paths have been deleted in order to more clearly show the operation of the processor unit during the mode, although they exist as illustrated in FIG. 5. The MUX function that the PE 302 is configured to execute is described above in more detail with reference to FIG. 7B. Additionally, the variable enA is now under control of BF4 as well: the formula enA=en0*en2+˜en0*˜en2 is changed to enA=˜BF4*(en0*en2+˜en0*˜en2)+BF4*en2. In this mode, the multiplexer selections are as follows: (i) ˜en2=0 causes the multiplexer 310 to select the output 371-373 of the PE (MUX) 302, (ii) enA=1 causes the multiplexer 514 to select the output 354 of the multiplexer 312, (iii) enB=1 causes the multiplexer 508 to select the output 518 of the multiplexer 514, and (iv) en1=0 causes the multiplexer 320 to select the output 360 of the multiplexer 314. Also note that the output 354 of the multiplexer 312 is fed into the PE (MUX) 302 as an input (C). Note that the output 371-373 of the PE (MUX) 302 does not bypass the shift register 308 in this mode bus is fed into the shift register 308.

Usage of both the AOI3 and the MUX functions create a much more efficient logic computation approach. By feeding a third input variable back in to the PE, the MUX or AOI3 operation can take place in a single cycle. Without this third input, the MUX or AOI3 operation requires 3 PE operations to be completed. Even though the PE that performs the MUX or AOI3 operation is not able to produce 2 independent output variables needed for the n PE's in the grid to operate upon, it is possible that the third variable, such as the selector for a MUX function, can be shared among several PEs that are all computing a similar function (e.g. a MUX function applied to a bus—each bit can be in a different PE, but the controlling signal is the same for each MUX operation). Care needs to be taken in scheduling, as multi-bit operations cause additional dependencies in the computation graph.

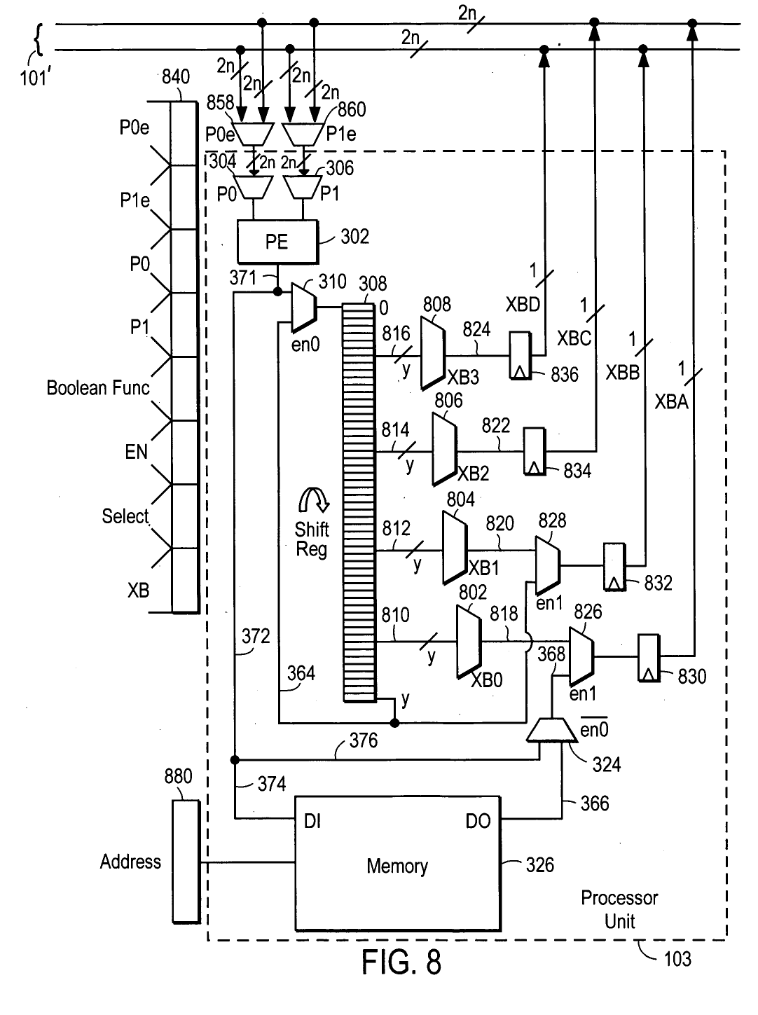

FIG. 8 is a circuit diagram illustrating a single processor unit of the simulation processor according to a sixth embodiment of the present invention. The processor unit shown in FIG. 8 is the same as the one shown in FIG. 3, with a few significant differences. The processor unit is controlled by an instruction word 840 comprised of P0e, P1e, P0, P1, Boolean Func, EN, Select, and XB. XB can be any combination of XB0, XB1, XB2, and XB3, as will be explained below. The memory 326 is addressed by an address signal 880. As compared to the processor unit in FIG. 3, the processor unit of FIG. 8 includes four multiplexers 802, 804, 806, 808 for selecting outputs from the shift register 308. The multiplexers 802, 804 are controlled by XB0, XB1, respectively, and are configured identically to the multiplexers 314, 312, respectively, of FIG. 3. The outputs 818, 820 of the multiplexers 802, 804 are fed into the flip flops 830, 832, respectively. The two additional multiplexers 806, 808 are controlled by XB2, XB3, respectively, and their outputs 822, 824 are fed into the flip flops 834, 836, respectively. The outputs XBA, XBB, XBC, XBD of the flip flops 830, 832, 834, 836 respectively, are input to the crossbar 101′, which is in this embodiment a 4n crossbar. The multiplexer 858 selects 2n bits from the 4n crossbar 101′ in response to the value of P0e, and the multiplexer 860 also selects another 2n bits from the 4n crossbar 101′ in response to the value of P1e. Note that each of the multiplexers 858, 860 can actually be implemented as 2n sets of 2-bit to 1-bit multiplexers, although they are shown in FIG. 8 as single multiplexers. The 2n bit output of the multiplexer 858 is input to the multiplexer 304 which selects 1 bit in response to the value of P0 as an input to the PE 302, and the other 2n bit output of the multiplexer 860 is input to the multiplexer 306 which also selects 1 bit in response to the value of P1 as another input to the PE 302. In this architecture, each PE produces 4 Data Out signals. For n PE's, a total of 4*n Data Out signals are thus created. Each PE produces only one bit output onto each of the XBA, XBB, XBC and XBD signals. The collective amount for n PE's is n signals for each of the XBA, XBB, XBC and XBD signals. Using P0e and P1e enables a more efficient multiplexer selector to be utilized.

Note that all of the multiplexers 802, 804, 806, 808 do not have to be used actively to select outputs from the shift register 308, and that the number of bits in the XB0, XB1, XB2, XB3 fields of the XB signal can be arranged in a variety of ways. For example, if the shift register 308 has a depth of 256 (=28) and 21 bits are allotted to the XB signal, the XB0, XB1, XB2, XB3 can have 5, 5, 6, and 5 bits, respectively, with each of the multiplexers 802, 804, 806, 808 capable of selecting from part of the shift register 308. For another example, if the shift register 308 has a depth of 256 (=28) and 21 bits are allotted to the XB signal, the XB0, XB1, XB2, XB3 can have 8, 7, 5, and 0 bits, respectively, with the multiplexer 802 capable of selecting from all of the entries of the shift register 308, the multiplexers 804, 806 capable of selecting from parts of the shift register 308, and the multiplexer 808 not being used. For still another example, the XB0, XB1, XB2, XB3 can have 0, 0, 5, and 0 bits, respectively, with only the multiplexer 806 being capable of selecting from part of the shift register 308, enabling the bits for XB0 and XB1 and XB3 to be combined to form a memory address for a read or a write instruction at the same time.

Additionally, the memory port DO width can be increased to, in this case, a 4-bit output, reading from the same address, and allowing the XB0 thru XB3 to carry one, two or more bits from the memory to the crossbar. A possible mapping is shown below in Table 5. In this table, DO-0 represents the first bit, bit0, from the memory DO port, DO-1 represents the second bit, bit1, and so on. Also the width of the multiplexers is shown, e.g. if 5 bits are available for XBA, than XBA can select 2⁵=32 locations from the shift register 308. Table 5 shows a mapping for 4 XB selectors with 4 possible mapping modes. This illustrates both the shallow (mode 0) versus deep (mode 1) trade-off as well as the multi-memory bit modes (Mem-1 and Mem-2). Other variations are possible.

TABLE 5
Multifunctional XB selectors

| MODE | XBA | XBB | XBC | XBD |
|---|---|---|---|---|
| 0 | 5 | 5 | 6 | 5 |
| | (32) | (32) | (64) | (32) |
| 1 | 8 | 8 | 4 | PE-out |
| | (256) | (256) | (16) | |
| Mem-1 | DO-0 | DO-1 | 5 | PE-out |
| 16-bit address | | | (32) | |
| Mem-2 | DO-0 | DO-1 | DO-2 | DO-3 |
| 21-bit address | | | | |

Note that the PE-out operation from FIG. 5 is assumed in Table 5 but not shown in FIG. 8.

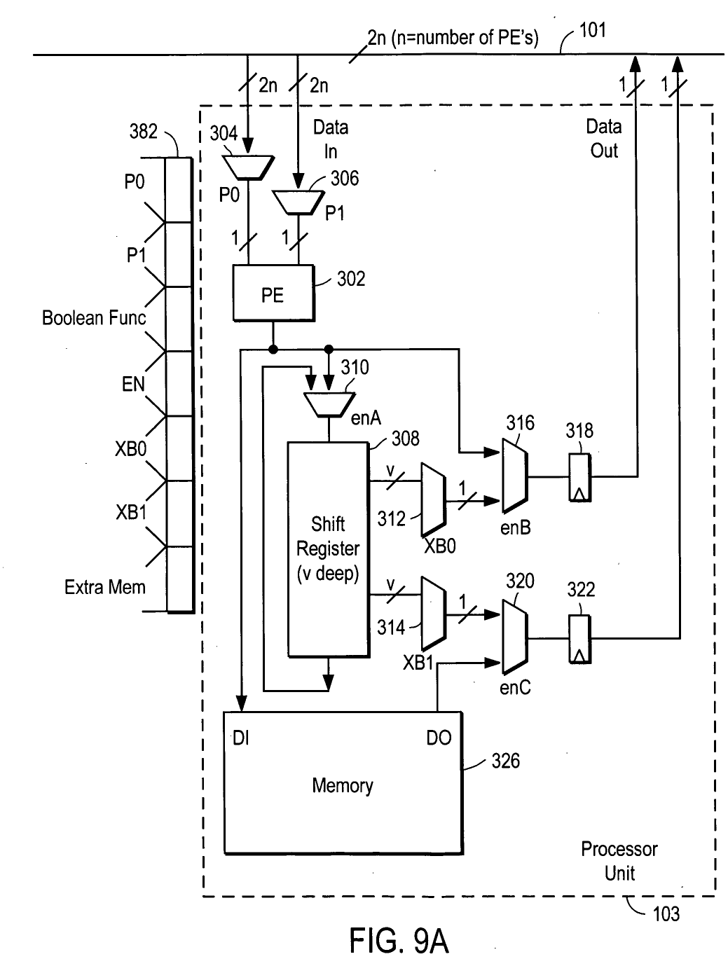

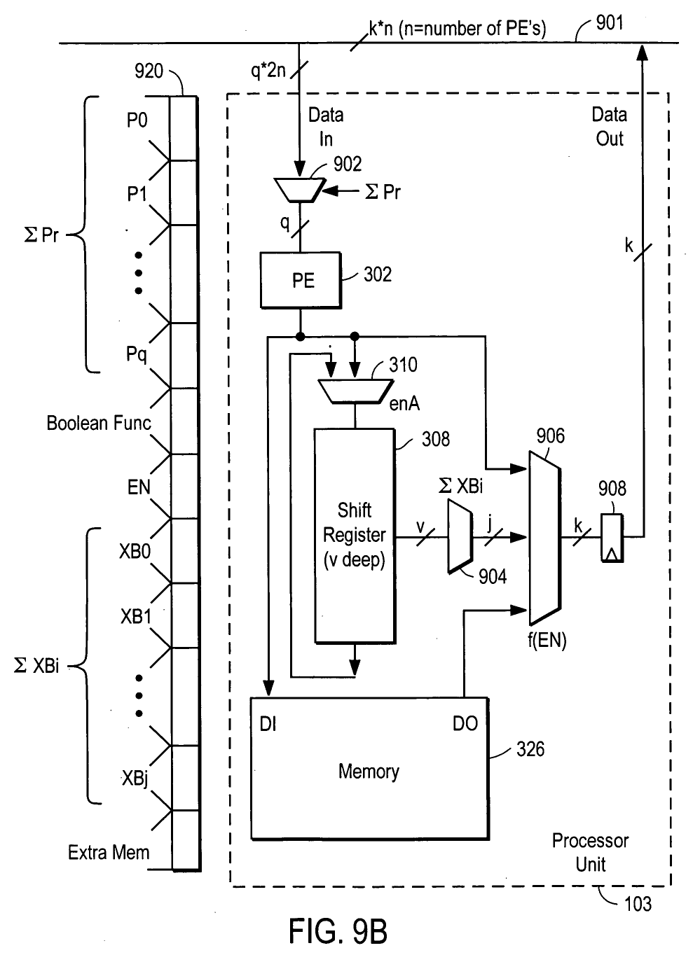

FIG. 9A shows a more generalized description of the PE and its related instruction word, generalizing the embodiment of FIG. 3. The embodiment of FIG. 9A is substantially the same as the embodiment of FIG. 3, except that it is more generalized with the multiplexer 310 now being controlled by enA, the multiplexer 316 now being controlled by enB, and the multiplexer 320 now being controlled by enC. It was mentioned above that the bits en2, en1 and en0 are not needed for direct steering, as was shown in FIG. 5A thru 5G. Rather, it was implied that there are a number of operating modes under Op Code control. Here, enA=f (en2, en1, en0), or enA=f_{A}(EN), and similarly enB=f_{B}(EN), and enC=f_{C}(EN), where f(x) refers to a function of x. By defining the functions f_{A}, f_{B}, and f_{C}, the simulation processor can be utilized in a more versatile or customized manner. Note that the address field for the memory 326 is not shown in FIG. 9A for simplicity, although they exist in the actual circuit.

FIG. 9B shows a more generalized description of the PE and its related instruction word, generalizing the embodiment of FIG. 8. In FIG. 9B, the instruction word 920 comprises bits P0 thru Pq represented as ΣPr, Boolean Func, EN, the sum of all bits XB0 thru XBj represented as ΣXBi, and Extra Mem. The multiplexer 902 is a q*2n bit to q bit multiplexer controlled by ΣPr, the multiplexer 904 is a v bit to j bit multiplexer controlled by ΣXBi, and the multiplexer 906 is a (j+2) bit to k bit multiplexer controlled by f(EN). This assumes that all the bits ΣXBi are used to control the multiplexer 904. Also, enA=f_{A}(EN). The crossbar 901 is a k×n crossbar. Here, n, q, k, and j are integers not less than 2. One can represent FIG. 9A in FIG. 9B by selecting q=2, k=2 and j=2. Other combinations are possible. Note that the address field for the memory 326 is not shown in FIG. 9B for simplicity, although they exist in the actual circuit.

The generalization depicted in FIGS. 9A and 9B show that compression can be utilized to enable both wide input multiplexing with few output signals while narrow input multiplexing with more output signals. A deeper shift register can thus be created that is accessible under dynamic instruction register control. This method enables significant increase in the depth of the shift register and addition to both the input data width and the output data width of the processor unit, without adding a significant amount of data bits to the instruction register. This enables more flexible architectures to be created which allows compiler algorithms to be utilized that increase the effective utilization of the processor grid (shown in FIG. 2). For example, combining both FIGS. 7 and 8 enable the local processor unit to consume 3 variables, while still being able to produce another set of variables for the crossbar. With proper balancing, there will be sufficient variables available in the crossbar to avoid the requirement of variable sharing, hence enhancing the efficiency of the processor grid.

In addition, fields such as Pi or XBi can be shared between adjacent PE's, enabling deeper addressing into the shift register, but only allowing one of the adjacent PE's to bring out the signal. This can also be done for memory access. This enables architectures that enable more Data Out signals per PE, but implies that not all Data Out signals can be used independently. The increased number of Data Out signals however does enable a more efficient architecture to be created, as more variables can be presented into the crossbar than can be consumed by all the PE's collectively, leading to a more efficient scheduling of the instructions for VLIW processor, increasing both its capacity and performance. We mention this merely as a reference as these are merely extensions of the described architecture: they allow for resource sharing and implementation trade-offs.

The present invention has the advantage that the simulation processor may use fewer bits in the instructions for the simulation processor, because the shift register does not require input address signals. Additional input multiplexers are not needed to address the shift register, thereby simplifying and reducing the number of components in the circuitry of the simulation processor. Also, the embodiment of FIG. 5 has circuitry to bypass the shift register, if necessary to reduce the amount of processing time. The present invention has the additional advantage that the shift register 308 is interconnected with the local memory 326 in such a way that the store mode and load mode are non-blocking, i.e., the store mode and the load mode may be performed simultaneously with the evaluation mode of the simulation processor.

Although the present invention has been described above with respect to several embodiments, various modifications can be made within the scope of the present invention. For example, the shift register 308 may be used with the PE 302 in many different configurations, and changes in the surrounding circuitry of the shift register 308 and PE 302 are still within the scope of the present invention. Although the embodiments of FIGS. 3, 4, 5, and 8 use one shift register 308 and the output of the shift register 308 is accessed by a plurality of multiplexers, it is also possible to have a corresponding number of multiple (e.g., 2 or 4) separate shift registers and have each of the plurality of multiplexers access the output of the corresponding one of the separate multiplexers. In such case, the contents of the data stored in the multiple shift registers would be replicated to be identical.

Additionally, although the present invention is described in the context of PEs that are the same, alternate embodiments can use different types of PEs and different numbers of PEs. The PEs also are not required to have the same connectivity or the same size or configuration of shift register. PEs may also share resources. For example, more than one PE may write to the same shift register and/or local memory. For example, two PEs may share a single local memory. The reverse is also true, a single PE may write to more than one shift register and/or local memory. A PE may also have more than 2 inputs from, and/or more than 2 outputs to, the crossbar. The use of the term “logic gate” herein is not limited to particular types of logic gates such as “AND,” “OR,” “NAND,” “NOR,” etc. Rather, “logic gate” herein refers to any type of logic operation or Boolean operation, regardless of whether it is standard or customized.

As another example, the instructions shown in FIGS. 3, 4, and 5 show distinct fields for P0, P1, etc. and the overall operation of the instruction set was described in the context of four primary operational modes. This was done for clarity of illustration. In various embodiments, more sophisticated coding of the instruction set may result in instructions with overlapping fields or fields that do not have a clean one-to-one correspondence with physical structures or operational modes. One example is given in the use of fields XB0, XB1 and Xtra Mem. These fields take different meanings depending on the rest of the instruction. In addition, symmetries or duality in operation may also be used to reduce the instruction length.

In another aspect, the simulation processor 100 of the present invention can be realized in ASIC (Application-Specific Integrated Circuit) or FPGA (Field-Programmable Gate Array) or other types of integrated circuits. It also need not be implemented on a separate circuit board or plugged into the host computer 110. There may be no separate host computer 110. For example, referring to FIG. 1, CPU 114 and simulation processor 100 may be more closely integrated, or perhaps even implemented as a single integrated computing device.

Although the present invention is described in the context of logic simulation for semiconductor chips, the VLIW processor architecture presented here can also be used for other applications. For example, the processor architecture can be extended from single bit, 2-state, logic simulation to 2 bit, 4-state logic simulation, to fixed width computing (e.g., DSP programming), and to floating point computing (e.g., IEEE-754). Applications that have inherent parallelism are good candidates for this processor architecture. In the area of scientific computing, examples include climate modeling, geophysics and seismic analysis for oil and gas exploration, nuclear simulations, computational fluid dynamics, particle physics, financial modeling and materials science, finite element modeling, and computer tomography such as MRI. In the life sciences and biotechnology, computational chemistry and biology, protein folding and simulation of biological systems, DNA sequencing, pharmacogenomics, and in silico drug discovery are some examples. Nanotechnology applications may include molecular modeling and simulation, density functional theory, atom-atom dynamics, and quantum analysis. Examples of digital content creation include animation, compositing and rendering, video processing and editing, and image processing. Accordingly, the disclosure of the present invention is intended to be illustrative, but not limiting, of the scope of the invention, which is set forth in the following claims.

What is claimed is:

1. A simulation processor for performing logic simulation of a logic design including a plurality of logic operations, the simulation processor comprising:
an interconnect system; and
a plurality of processor units communicatively coupled to each other via the interconnect system, wherein each of at least two of the processor units includes:
a processor element configurable to simulate at least one of the logic operations;
a shift register associated with the processor element and including a plurality of entries to store intermediate values during operation of the processor element, the shift register coupled to receive an output of the processor element;
one or more first-path multiplexers coupled between the output of the processor element and the interconnect system, the first-path multiplexers providing a path for bypassing the shift register to provide the output of the processor element to the interconnect system; and
one or more second-path multiplexers coupled between the shift register and the interconnect system, each of the second-path multiplexers for selecting one of the entries of the shift register and further for transferring the selected entry to the interconnect system.

2. The simulation processor of claim 1, wherein during an evaluation mode of the processor element during which the processor element simulates said at least one logic operation, the output of the processor element is coupled to the first-path multiplexers and provided to the interconnect system bypassing the shift register, and at least one of the second-path multiplexers couples the shift register to the interconnect system.

3. The simulation processor of claim 1, wherein during an evaluation mode of the processor element during which the processor element simulates said at least one logic operation, the output of the processor element is not provided to the interconnect system through the first-path multiplexers, and at least two of the second-path multiplexers couple the shift register to the interconnect system.

4. The simulation processor of claim 1, wherein each of the at least two processor units further comprises a memory associated with the processor element for storing data from the simulation processor and loading data to the simulation processor, and during a store mode, the output of the processor element is coupled to the memory without passing through the shift register, and at least one of the first-path multiplexers is coupled to receive and provide one of the entries of the shift register to the interconnect system.

5. The simulation processor of claim 1, wherein each of the at least two processor units further comprises a memory associated with the processor element for storing data from the simulation processor and loading data to the simulation processor, and during a store mode, the output of the processor element is coupled to the memory and to the shift register, and at least one of the first-path multiplexers is coupled to receive and provide one of the entries of the shift register to the interconnect system.

6. The simulation processor of claim 1, wherein each of the at least two processor units further comprises a memory associated with the processor element for storing data from the simulation processor and loading data to the simulation processor, and during a load mode of the processor element, an output of the memory is coupled to the interconnect system without passing through the shift register or the processor element, and the output of the processor element is coupled to the first-path multiplexers and provided to the interconnect system bypassing the shift register.

7. The simulation processor of claim 1, wherein each of the at least two processor units further comprises a memory associated with the processor element for storing data from the simulation processor and loading data to the simulation processor, and during a load mode of the processor element, an output of the memory is coupled to the interconnect system without passing through the shift register or the processor element, and the output of the processor element is coupled to the first-path multiplexers and provided to the interconnect system as well as coupled to the shift register.

8. The simulation processor of claim 1, wherein during a no-operation mode of the processor element during which the processor element does not simulate any logic operation, the output of the processor element is not provided to the shift register or to the interconnect system through the first-path multiplexers, and at least two of the second-path multiplexers couple the shift register to the interconnect system.

9. The simulation processor of claim 1, wherein:
the second-path multiplexers include a first multiplexer and a second multiplexer, each of the first and second multiplexers coupled to receive one of the entries of the shift register; and
the first-path multiplexers include a third multiplexer, a fourth multiplexer, and a fifth multiplexer, the third multiplexer coupled to select either an output of the second multiplexer or the output of the processor element, the fourth multiplexer coupled to select either the output of the processor element or a first entry of the shift register, and the fifth multiplexer coupled to select either an output of the third multiplexer or an output of the fifth multiplexer.

10. The simulation processor of claim 9, further comprising:
a sixth multiplexer coupled to select either the output of the processor element or an output of a memory associated with the processor element for storing data from the simulation processor and loading data to the simulation processor;
a seventh multiplexer coupled to select either an output of the first multiplexer or an output of the sixth multiplexer; and
an eighth multiplexer coupled to select either the output of the processor element or a last entry of the shift register.

11. The simulation processor of claim 10, wherein during an evaluation mode of the processor element during which the processor element simulates said at least one logic operation:
the third multiplexer selects the output of the processor element;
the fifth multiplexer selects the output of the third multiplexer;
the seventh multiplexer selects the output of the first multiplexer; and
the eighth multiplexer selects the last entry of the shift register.

12. The simulation processor of claim 10, wherein during an evaluation mode of the processor element during which the processor element simulates said at least one logic operation:
the third multiplexer selects the output of the second multiplexer;
the fifth multiplexer selects the output of the third multiplexer;
the seventh multiplexer selects the output of the first multiplexer; and
the eighth multiplexer selects the output of the processor element.

13. The simulation processor of claim 10, wherein during a store mode of the processor element:
the fourth multiplexer selects the first entry of the shift register;
the fifth multiplexer selects the output of the fourth multiplexer;
the sixth multiplexer selects the output of the processor element;
the seventh multiplexer selects the output of the sixth multiplexer; and
the eighth multiplexer selects the last entry of the shift register.

14. The simulation processor of claim 10, wherein during a store mode of the processor element:
the fourth multiplexer selects the first entry of the shift register;
the fifth multiplexer selects the output of the fourth multiplexer;
the sixth multiplexer selects the output of the processor element;
the seventh multiplexer selects the output of the sixth multiplexer; and
the eighth multiplexer selects the output of the processor element.

15. The simulation processor of claim 10, wherein during a load mode of the processor element:
the fourth multiplexer selects the output of the processor element;
the fifth multiplexer selects the output of the fourth multiplexer;
the sixth multiplexer selects the output of the memory;
the seventh multiplexer selects the output of the sixth multiplexer; and
the eighth multiplexer selects the last entry of the shift register.

16. The simulation processor of claim 10, wherein during a load mode of the processor element:
the fourth multiplexer selects the output of the processor element;
the fifth multiplexer selects the output of the fourth multiplexer;
the sixth multiplexer selects the output of the memory;
the seventh multiplexer selects the output of the sixth multiplexer; and
the eighth multiplexer selects the output of the processor element.

17. The simulation processor of claim 10, wherein during a no-operation mode of the processor element during which the processor element does not simulate any logic operation:
the third multiplexer selects the output of the second multiplexer;
the fifth multiplexer selects the output of the third multiplexer;
the seventh multiplexer selects the output of the first multiplexer; and
the eighth multiplexer selects the last entry of the shift register.

18. The simulation processor of claim 1, wherein each of the at least two processor units further comprises a multiplexer for either coupling an output of the processor element to the shift register or refreshing the shift register.

19. The simulation processor of claim 1, wherein the simulation processor is implemented on a board that is pluggable into a host computer.

20. The simulation processor of claim 19, wherein the simulation processor has direct access to a main memory of the host computer.

21. The simulation processor of claim 1, wherein the interconnect system comprises a crossbar.

22. A VLIW processor for performing logic operations, comprising:
an interconnect system; and
a plurality of processor units communicatively coupled to each other via the interconnect system, wherein each of at least two of the processor units includes:
a processor element configurable to implement at least a portion of the logic operations;
a shift register associated with the processor element and including a plurality of entries to store intermediate values during operation of the processor element, the shift register coupled to receive an output of the processor element;
one or more first-path multiplexers coupled between an output of the processor element and the interconnect system, the first-path multiplexers providing a path for bypassing the shift register to provide the output of the processor element to the interconnect system; and
one or more second-path multiplexers coupled between the shift register and the interconnect system, each of the second-path multiplexers for selecting one of the entries of the shift register and further for transferring the selected entry to the interconnect system.

23. A simulation processor for performing logic simulation of a logic design including a plurality of logic operations, the simulation processor comprising:
an interconnect system; and
a plurality of processor units communicatively coupled to each other via the interconnect system, wherein each of at least two of the processor units includes:
a processor element configurable to simulate at least one of the logic operations;
a shift register associated with the processor element and including a plurality of entries to store intermediate values during operation of the processor element, the shift register coupled to receive an output of the processor element; and
a plurality of multiplexers coupled between the shift register and the interconnect system, each of the multiplexers for selecting one of the entries of the shift register and further for transferring the selected entry to the interconnect system, each of the multiplexers configured to select said one of the entries of the shift register in response to a corresponding one of a plurality of selection signals, and at least one of the selection signals having a different number of bits compared to other ones of the selection signals.

24. The simulation processor of claim 23, wherein the plurality of multiplexers comprises a first multiplexer, a second multiplexer, a third multiplexer, and a fourth multiplexer configured to select said one of the entries of the shift register in response to a first selection signal, a second selection signal, a third selection signal, and a fourth selection signal, respectively.

25. The simulation processor of claim 24, wherein the fourth selection signal has zero bits such that the fourth multiplexer is not active.

26. The simulation processor of claim 24, wherein the third selection signal has a different number of bits compared to the first, second, and fourth selection signals, such that the third multiplexer is configured to access a different number of entries of the shift register compared to the first, second, and fourth multiplexers.

27. A simulation processor for performing logic simulation of a logic design including a plurality of logic operations, the simulation processor comprising:
an interconnect system; and
a plurality of processor units communicatively coupled to each other via the interconnect system, wherein each of at least two of the processor units includes:
a processor element configurable to simulate at least one of the logic operations;
a shift register associated with the processor element and including a plurality of entries to store intermediate values during operation of the processor element, the shift register coupled to receive an output of the processor element; and
a plurality of multiplexers coupled between the shift register and the interconnect system, each of the multiplexers for selecting one of the entries of the shift register and further for transferring the selected entry to the interconnect system, each of the multiplexers being controlled by a control signal which is a function of operation codes indicative of the modes of the processor element.

28. A simulation processor for performing logic simulation of a logic design including a plurality of logic operations, the simulation processor comprising:
an interconnect system; and
n processor units communicatively coupled to each other via the interconnect system where n being an integer not less than 2, wherein each of at least two of the processor units includes:
a processor element configurable to simulate at least one of the logic operations;
a shift register associated with the processor element and including a plurality of entries to store intermediate values during operation of the processor element, the shift register coupled to receive an output of the processor element and having a depth of v;
a q×2n bit to q bit input multiplexer for selecting q bit input data from the interconnect system, q being not less than 2;
a v×j bit to j bit output multiplexer for selecting j bit output data from the shift register, j being an integer not less than 2; and
a (j+2) bit to k bit multiplexer for selecting k bit output data from the j bit output data from the shift register, the output data of the processor element, and output data from a memory associated with the processor element for storing data from the simulation processor and loading data to the simulation processor, in response to a control signal which is a function of operation codes indicative of the modes of the processor element, k being an integer not less than 2, and the (j+2) bit to k bit multiplexer further transferring the k bit output data to the interconnect system.
